(19) United States
(12) Patent Application Publication
(10) Pub. No.: US 2018/0203744 A1
(43) Pub. Date: Jul. 19, 2018

(54) DATA INGESTION AND ANALYTICS PLATFORM WITH SYSTEMS, METHODS AND COMPUTER PROGRAM PRODUCTS USEFUL IN CONJUNCTION THEREWITH

(71) Applicants: Alexander WIESMAIER, Ober-Ramstadt (DE); Oliver HALLER, Rodgau (DE)

(72) Inventors: Alexander WIESMAIER, Ober-Ramstadt (DE); Oliver HALLER, Rodgau (DE)

(21) Appl. No.: 15/865,628

(22) Filed: Jan. 9, 2018

Related U.S. Application Data
(60) Provisional application No. 62/443,974, filed on Jan. 9, 2017.

(51) Int. Cl. G06F 9/52; G06F 9/48; G06F 17/30; G06F 9/50

(52) U.S. Cl. CPC G06F 9/52; G06F 9/505; G06F 17/30952; G06F 9/4881

(57) ABSTRACT

Data processing system comprising: at least one processing layer split into plural lanes operative for concurrent processing, using processor circuitry, in accordance with different analytics requirements; at least one initial data ingestion layer operative for ingestion of data and routing data, using processor circuitry, to one of the plural lanes; and a data storage layer aka persistence layer, receiving and storing outputs from the plural lanes, wherein the lanes include at least one of: at least one batch processing lane operative for batch processing, using processor circuitry, of chunks of data received from the data storage layer; and at least one stream processing lane to which data delivered as a stream of data packets is routed by the ingestion layer for analytics performed, using processor circuitry, for at least some of the packets.

### REFERENCE TO CO-PENDING APPLICATIONS

Priority is claimed from U.S. provisional application No. 62/443,974, entitled ANALYTICS PLATFORM and filed on 9 Jan. 2017, the disclosure of which application/s is hereby incorporated by reference.

### FIELD OF THIS DISCLOSURE

The present invention relates generally to software, and more particularly to analytics software such as IoT analytics.

### BACKGROUND FOR THIS DISCLOSURE

Lambda Architecture as is an architectural pattern described by Nathan Marz in [72] which is designed to process massive amounts of data using stream and batch processing techniques in two parallel processing layers. The stream processing layer is designed to supply results as fast as possible while the batch processing layer guarantees completeness and has final authority over correctness. Once data has been processed in the slower batch layer the results from the speed layer are no longer needed and can be disposed of. This inefficiency of performing all computations twice and the need to keep the two code bases for the layers in sync are major criticisms of the architecture. [68]

The Kappa Architecture as shown in prior art FIG. 2.2 is a streaming data processing architecture designed as a simplification and an improvement over the Lambda Architecture. Jay Kreps first discussed its concepts in [69] and later named it the Kappa Architecture in [68]. Kappa forgoes the batch processing layer and instead uses a single stream processing layer to handle all processing. This layer also handles all reprocessing which would fall to the batch layer in a Lamda Architecture. This enables the Kappa architecture to use a single code base which is a big criticism of the Lambda architecture and also avoids the complexity of dealing with the edges of batches in the batch layer.

Big data frameworks include:

Apache Hadoop, an open source platform that allows the distributed processing of large data sets on clusters using the MapReduce programming model (https://hadoop,apache.org/). Also part of Hadoop are HDFS, a distributed filesystem, and YARN, a framework for scheduling jobs and managing cluster resources. Hadoop is the basis for many other projects like Cassandra, HBase, Pig and Spark.

Apache Spark, a data processing engine compatible with Hadoop. It comes with libraries for interactive SQL queries, machine learning and graph processing algorithms (https://spark.apache.org/). Spark supports fault tolerant batch and stream processing with exactly once semantic via its Spark Streaming extension. Internally Spark Streaming divides the streaming data into micro-batches which are then processed by the Spark Engine.

Apache Samza, a distributed stream processing framework that follows the Kappa Architecture pattern (https://samza,apache.org/). In Samza streams are the inputs and outputs of jobs. A stream is a partitioned, ordered-per-partition, replayable, multi-subscriber, lossless sequence of messages that buffers and isolates processing stages from each other. Samza supports durable and stateful computations.

Apache Flink, a platform for distributed stream and batch data processing (https://flink.apache.org/). While commonly used in combination with Hadoop, Flink also works independently. It supports the notion of event time which can be used in combination with its flexible windowing strategies to easily process out of order events. Flink also provides stateful computations with exactly once semantic.

IoT and analytics platforms include the following:

Google, Xivley and EVRYTHNG provide proprietary cloud deployments of their platforms themselves and cannot be deployed in the AWS cloud. ServIoTicy limited in the choices of technologies.

MillWheel is a framework for building low-latency data processing applications available as a service in the Google cloud. Users can specify a directed computation graph and application code for the individual nodes. The system manages persistent state and flow of records.

Xivley and EVRYTHNG are both fully managed IoT cloud platforms which provide the ability to manage smart devices connected to the platform. Both offer integration points for other business and analytics systems to access the gathered data as well as integrated dashboard visualizations.

ServIoTicy is a scalable stream processing platform for the IoT is described in (https://github.com/servioticy). It is developed at the Barcelona Supercomputing Center as a part of the COMPOSE research project (https://platform.compose-project.eu/servioticy/). The platform provides means for data aggregation and processing and is completely based on open-source software such as Couchbase, Storm, Apollo and Jetty. It is developed with auto scalability in mind.

Pubished in (https://ieeexplore.ieee.org/document/7509805/) is an implementation of a platform supporting the creation of big data analytics workflows. The platform integrates a variety of analytics tools which data scientists can use to build their own processing pipelines. It is focused on analytics and does not provide capabilities for gathering data.

AScale is an auto scalable system to speed up the ETL process and improve data freshness in data warehouses. It uses parallelization for each of the ETL steps. This enables auto scalability by adding processing capacity to individual steps based on predefined performance thresholds.

Hadoop auto scaling, e.g. an automatic method to size a cluster to the expected workload when it is created is proposed in [64]. profiling, estimation and simulation techniques are used to analyze Hadoop MapReduce jobs to support user in creating clusters with the number and size of instances that is optimized for time and cost. True auto scaling approaches are proposed in [70]. The framework uses a predictive auto scaling algorithm for adjusting the size of Hadoop clusters. In [82] a framework uses machine learning techniques to predict a minimum cluster composition that satisfies the service level objective.

Conventional technology constituting background to certain embodiments of the present invention is described in the following publications inter alia:
[1] Airflow Documentation. Concepts. The Apache Software Foundation. 2016. url: https://airflow.apache.org/concepts.html (last visited on Dec. 10, 2016).
[2] Airflow Documentation. Scheduling & Triggers. The Apache Software Foundation. 2016. url: https://airflow.apache.org/scheduler.html (last visited on Dec. 10, 2016).
[3] Tyler Akidau et al. “MillWheel: Fault-Tolerant Stream Processing at Internet Scale”. In: Very Large Data Bases. 2013, pp. 734-746.
[4] Tyler Akidau et al. “The Dataflow Model: A Practical Approach to Balancing Correctness, Latency, and Cost in Massive-Scale, Unbounded, Out-of-Order Data Processing”. In: Proceedings of the VLDB Endowment 8 (2015), pp. 1792-1803.
[5] Amazon Athena User Guide. What is Amazon Athena? Amazon Web Services, Inc. 2016. url: https://docs.aws.amazon.com/athena/latest/ug/what-is.html (last visited on Dec. 10, 2016).
[6] Amazon DynamoDB Developer Guide. Amazon Web Services, Inc., 2016. Chap. DynamoDB Core Components, pp. 3-8.
[7] Amazon DynamoDB Developer Guide. Amazon Web Services, Inc., 2016. Chap. Provisioned Throughput, pp. 16-21.
[8] Amazon DynamoDB Developer Guide. Amazon Web Services, Inc., 2016. Chap. Limits in DynamoDB, pp. 607-613.
[9] Amazon Elastic MapReduce Documentation. Apache Flink. Amazon Web Services, Inc. 2016. url: http://docs.aws.amazon.com/ElasticMapReduce/latest/ReleaseGuide/emr-flink.html (last visited on Dec. 30, 2016).
[10] Amazon Elastic MapReduce Documentation Release Guide. Applications. Amazon Web Services, Inc. 2016. url: http://docs.aws.amazon.com//ElasticMapReduce/latest/ReleaseGuide/emr-release-components. html#d0e650 (last visited on Dec. 13, 2016).
[11] Amazon EMR Management Guide. Amazon Web Services, Inc., 2016. Chap. File Systems Compatible with Amazon EMR, pp. 50-57.
[12] Amazon EMR Management Guide. Amazon Web Services, Inc., 2016. Chap. Scaling Cluster Resources, pp. 182-191.
[13] Amazon EMR Release Guide. Hue. Amazon Web Services, Inc. 2016. url: https://docs.aws.amazon.com/ElasticMapReduce/latest/ReleaseGuide/emr-hue.html (last visited on Dec. 10, 2016).
[14] Amazon Kinesis Firehose. Amazon Web Services, Inc., 2016. Chap. Amazon Kinesis Firehose Data Delivery, pp. 27-28.
[15] Amazon Kinesis Firehose. Amazon Web Services, Inc., 2016. Chap. Amazon Kinesis Firehose Limits, p. 54.
[16] Amazon Kinesis Streams API Reference. UpdateShardCount. Amazon Web Services, Inc. 2016. url: http://docs.aws.amazon.com/kinesis/latest/APIReference/API_UpdateShardCount.html (last visited on Dec. 11, 2016).
[17] Amazon Kinesis Streams Developer Guide. Amazon Web Services, Inc., 2016. Chap. Streams High-level Architecture, p. 3.
[18] Amazon Kinesis Streams Developer Guide. Amazon Web Services, Inc., 2016. Chap. What Is Amazon Kinesis Streams?, pp. 1-4.
[19] Amazon Kinesis Streams Developer Guide. Amazon Web Services, Inc., 2016. Chap. Working With Amazon Kinesis Streams, pp. 96-101.
[20] Amazon Kinesis Streams Developer Guide. Amazon Web Services, Inc., 2016. Chap. Amazon Kinesis Streams Limits, pp. 7-8.
[21] Amazon RDS Product Details. Amazon Web Services, Inc. 2016. url: https://aws.amazon.com/rds/details/ (last visited on Jan. 1, 2017).
[22] Amazon Simple Storage Service (S3) Developer Guide. Bucket Restrictions and Limitations. Amazon Web Services, Inc. 2016. url: http://docs.aws.amazon.com/AmazonS3/latest/dev/BucketRestrictions.html (last visited on Dec. 13, 2016).
[23] Amazon Simple Storage Service (S3) Developer Guide. Request Rate and Performance Considerations. Amazon Web Services, Inc. 2016. url: http://docs.aws.amazon.com/AmazonS3/latest/dev/request rate perf-considerations.html (last visited on Dec. 23, 2016).
[24] Amazon Simple Workflow Service Developer Guide. Amazon Web Services, Inc., 2016. Chap. Basic Concepts in Amazon SWF, pp. 36-51.
[25] Amazon Simple Workflow Service Developer Guide. Amazon Web Services, Inc., 2016. Chap. AWS Lambda Tasks, pp. 96-98.
[26] Amazon Simple Workflow Service Developer Guide. Amazon Web Services, Inc., 2016. Chap. Development Options, pp. 1-3.
[27] Amazon Simple Workflow Service Developer Guide. Amazon Web Services, Inc., 2016. Chap. Amazon Simple Workflow Service Limits, pp. 133-137.
[28] Ansible Documentation. Amazon Cloud Modules. Red Hat, Inc. 2016. url: http://docs.ansible.com/ansible/list_of_cloud_modules.html# amazon (last visited on Dec. 9, 2016).
[29] Ansible Documentation. Create or delete an AWS CloudFormation stack. Red Hat, Inc. 2016. url: http://docs.ansible.com/ansible/cloudformation_module.html (last visited on Dec. 9, 2016).
[30] Apache Airflow (incubating) Documentation. The Apache Software Foundation. 2016. url: https://airflow.apache.org/#apache airflow-incubating-documentation (last visited on Dec. 10, 2016).
[31] Apache Camel. The Apache Software Foundation. 2016. url: http://camel.apache.org/component.html (last visited on Dec. 31, 2016).
[32] Apache Camel Documentation. Camel Components for Amazon Web Services. The Apache Software Foundation. 2016. url: https://camel.apache.org/aws.html (last visited on Dec. 18, 2016).
[33] Apache Flink. Features. The Apache Software Foundation. 2016. url: https://flink.apache.org/features.html (last visited on Dec. 28, 2016).
[34] AWS Batch Product Details. Amazon Web Services, Inc. 2016. url: https://aws.amazon.com/batch/details/ (last visited on Dec. 30, 2016).
[35] AWS CloudFormation User Guide. Amazon Web Services, Inc., 2016. Chap. What is CloudFormation?, pp. 1-2.
[36] AWS CloudFormation User Guide. Amazon Web Services, Inc., 2016. Chap. Template Reference, pp. 425-429.
[37] AWS CloudFormation User Guide. Amazon Web Services, Inc., 2016. Chap. Template Reference, pp. 525-527.
[38] AWS CloudFormation User Guide. Amazon Web Services, Inc., 2016. Chap. Custom Resources, pp. 398-423.
[39] AWS CloudFormation User Guide. Amazon Web Services, Inc., 2016. Chap. Template Reference, pp. 1303-1304.
[40] AWS Data Pipeline Developer Guide. Amazon Web Services, Inc., 2016. Chap. Data Pipeline Concepts, pp. 4-11.
[41] AWS Data Pipeline Developer Guide. Amazon Web Services, Inc., 2016. Chap. Working with Task Runner, pp. 272-276.
[42] AWS Data Pipeline Developer Guide. Amazon Web Services, Inc., 2016. Chap. AWS Data Pipeline Limits, pp. 291-293.
[43] AWS IoT Developer Guide. Amazon Web Services, Inc., 2016. Chap. AWS IoT Components, pp. 1-2.
[44] AWS IoT Developer Guide. Amazon Web Services, Inc., 2016. Chap. Rules for AWS IoT, pp. 122-132.
[45] AWS IoT Developer Guide. Amazon Web Services, Inc., 2016. Chap. Rules for AWS IoT, pp. 159-160.
[46] AWS IoT Developer Guide. Amazon Web Services, Inc., 2016. Chap. Security and Identity for AWS IoT, pp. 75-77.
[47] AWS IoT Developer Guide. Amazon Web Services, Inc., 2016. Chap. Message Broker for AWS IoT, pp. 106-107.
[48] AWS Lambda Developer Guide. Amazon Web Services, Inc., 2016. Chap. AWS Lambda: How It Works, pp. 151,157-158.
[49] AWS Lambda Developer Guide. Amazon Web Services, Inc., 2016. Chap. Lambda Functions, pp. 4-5.
[50] AWS Lambda Developer Guide. Amazon Web Services, Inc., 2016. Chap. AWS Lambda Limits, pp. 285-286.
[51] AWS Lambda Developer Guide. Amazon Web Services, Inc., 2016. Chap. AWS Lambda: How It Works, pp. 152-153.
[52] AWS Lambda Pricing. Amazon Web Services, Inc. 2016. url: https://aws.amazon.com/lambda/pricing/#lambda (last visited on Dec. 11, 2016).
[53] Azkaban 3.0 Documentation. Overview. 2016. url: http://azkaban.github.io/azkaban/docs/latest/#overview (last visited on Dec. 11, 2016).
[54] Azkaban 3.0 Documentation. Plugins. 2016. url: http://azkaban.github.io/azkaban/docs/latest/#plugins (last visited on Dec. 11, 2016).
[55] Ryan B. AWS Developer Forums. Thread: Rules engine->Action->Lambda function. Amazon Web Services, Inc. 2016. url: https://forums.aws.amazon.com/message.jspa?messageID=701402 #701402 (last visited on Dec. 9, 2016).
[56] Andrew Banks and Rahul Gupta, eds. MQTT Version 3.1.1. Quality of Service levels and protocol flows. OASIS Standard. 2014. url: http://docs.oasisopen.org/mqtt/mqtt/v3.1.1/os/mqttv3.1.1os.html #_Ref363045966 (last visited on Dec. 9, 2016).
[57] Erik Bernhardsson and Elias Freider. Luigi 2.4.0 documentation. Getting Started. 2016. url: https://luigi.readthedocs.io/en/stable/index.html (last visited on Dec. 9, 2016).
[58] Erik Bernhardsson and Elias Freider. Luigi 2.4.0 documentation. Execution Model. 2016. url: https://luigi.readthedocs.io/en/stable/execution_model.html (last visited on Dec. 9, 2016).
[59] Erik Bernhardsson and Elias Freider. Luigi 2.4.0 documentation. Design and limitations. 2016. url: https://luigi.readthedocs.io/en/stable/design_and_limitations.html (last visited on Dec. 9, 2016).
[60] Big Data Analytics Options on AWS. Tech. rep. January 2016.
[61] C. Chen et al. “A scalable and productive workflow-based cloud platform for big data analytics”. In: 2016 IEEE International Conference on Big Data Analysis (ICBDA). March 2016, pp. 1-5.
[62] Core Tenets of IoT. Tech. rep. Amazon Web Services, Inc., April 2016.
[63] Features|EVRYTHNG IoT Smart Products Platform. EVRYTHNG. 2016. url: https://evrythng.com/platform/features/ (last visited on Dec. 28, 2016).
[64] Herodotos Herodotou, Fei Dong, and Shivnath Babu. “No One (Cluster) Size Fits All: Automatic Cluster Sizing for Data-intensive Analytics”. In: Proceedings of the 2nd ACM Symposium on Cloud Computing. ACM. 2011, p. 18.
[65] How AWS IoT Works. Amazon Web Services, Inc. 2016. url: https://aws.amazon.com/de/iot/how-it-works/ (last visited on Dec. 29, 2016).
[66] ImmobilienScout24/emr-autoscaling. Instance Group Selection. ImmobilienScout24. 2016. url: https://github.com/ImmobilienScout24/emr-autoscaling#instance-group-selection (last visited on Dec. 11, 2016).
[67] IoT Platform Solution|Xivley. LogMeIn, Inc. 2016. url: https://www.xively.com/xively-iot-platform (last visited on Dec. 28, 2016).
[68] Jay Kreps. Questioning the Lambda Architecture. The Lambda Architecture has its merits, but alternatives are worth exploring. LinkedIn Corporation. Jul. 2, 2014. url: https://www.oreilly.com/ideas/questioning the-lambda-architecture (last visited on Dec. 21, 2016).
[69] Jay Kreps. The Log: What every software engineer should know about realtime data's unifying abstraction. LinkedIn Corporation. Dec. 16, 2013. url: https://engineering.linkedin.com/distributedsystems/log—what every software engineer should know about real time—datas-unifying (last visited on Dec. 29, 2016).
[70] Zhenlong Li et al. “Automatic Scaling Hadoop in the Cloud for Efficient Process of Big Geospatial Data”. In: ISPRS International Journal of Geo-Information 5.10 (2016), p. 173.
[71] Pedro Martins, Maryam Abbasi, and Pedro Furtado. “AScale: Auto-Scale in and out ETL+Q Framework”. In: Beyond Databases, Architectures and Structures. Advanced Technologies for Data Mining and Knowledge Discovery. Springer International Publishing Switzerland 2016, 2016.
[72] Nathan Marz and James Warren. Big Data. Principles and best practices of scalable realtime data systems. Greenwich, Conn., USA: Manning Publications Co., May 7, 2015, pp. 14-20.
[73] Angela Merkel. Merkel: Wir müssen uns sputen. Ed. by Presse and Informationsamt der Bundesregierung. Mar. 12, 2016. url: https://www.bundesregierung.de/Content/DE/Pressemitteilungen/BPA/2016/03/2016-03-12-podcast.html (last visited on Dec. 13, 2016).
[74] Kief Morris. Infrastructure as Code. Managing Servers in the Cloud. Sebastopol, Calif., USA: O'Reilly Media, Inc, 2016. Chap. Challenges and Principles, pp. 10-16.
[75] Oozie. Workflow Engine for Apache Hadoop. The Apache Software Foundation. 2016. url: https://oozie.apache.org/docs/4.3.0/index.html (last visited on Dec. 10, 2016).
[76] Oozie Specification. Parameterization of Workflows. The Apache Software Foundation. 2016. url: https://oozie.apache.org/docs/4.3.0/WorkflowFunctionalSpec.html #a3_Workflow_Nodes (last visited on Dec. 10, 2016).
[77] Oozie Specification. Parameterization of Workflows. The Apache Software Foundation. 2016. url: https://oozie.apache.org/docs/4.3.0/WorkflowFunctionalSpec.html #a4Parameterization_of_Workflows (last visited on Dec. 10, 2016).
[78] Press Release: Worldwide Big Data and Business Analytics Revenues Forecast to Reach $187 Billion in 2019. International Data Corporation. 2016. url: https://www.idc.com/getdoc.jsp?containerId=prUS41306516 (last visited on Dec. 12, 2016).
[79] Puppet module for managing AWS resources to build out infrastructure. Type Reference. Puppet, Inc. 2016. url: https://github.com/puppetlabs/puppetlabs-aws#types (last visited on Dec. 9, 2016).
[80] J. L. Pérez and D. Carrera. “Performance Characterization of the servIoTicy API: An IoT-as-a-Service Data Management Platform”. In: 2015 IEEE First International Conference on Big Data Computing Service and Applications. March 2015, pp. 62-71.
[81] Samza. Comparison Introduction. The Apache Software Foundation. 2016. url: https://samza.apache.org/learn/documentation/0.11/comparisons/introduction.html (last visited on Dec. 29, 2016).
[82] S. Sidhanta and S. Mukhopadhyay. “Infra: SLO Aware Elastic Auto-scaling in the Cloud for Cost Reduction”. In: 2016 IEEE International Congress on Big Data (BigData Congress). June 2016, pp. 141-148.
[83] Spark Streaming. Spark 2.1.0 Documentation. The Apache Software Foundation. 2017. url: https://spark.apache.org/docs/latest/streaming-programming-guide.html (last visited on Jan. 1, 2017).
[84] Álvaro Villalba et al. “servIoTicy and iServe: A Scalable Platform for Mining the IoT”. In: Procedia Computer Science 52 (2015), pp. 1022-1027.
[85] What Is Apache Hadoop? The Apache Software Foundation. 2016. url: https://hadoop.apache.org/#What+Is+Apache+Hadoop%3F (last visited on Dec. 23, 2016).

The Lambda Architecture of prior art FIG. 1a aka FIG. 2.1 is designed to process massive amounts of data using stream and batch processing techniques in two parallel processing layers.

The disclosures of all publications and patent documents mentioned in the specification, and of the publications and patent documents cited therein directly or indirectly, are hereby incorporated by reference. Materiality of such publications and patent documents to patentability is not conceded

### SUMMARY OF CERTAIN EMBODIMENTS

Certain embodiments seek to provide a typically Auto-scaling, typically infrastructure-as-code, typically serverless-first, data ingestion and analytics platform typically suitable for Cloud-based (Social) IoT and other data and resource intensive uses typically with (auto-)scaling data ingestion & analytics such as but not limited to Heed, Scale, PBR, DTA, Industry 4.0, Smart Cities Sports & Entertainment, 14.0, Smart City, with Cloud based or Cluster-based data ingestion & analytics.

Certain embodiments seek to provide exactly one data ingestion technology and/or a fixed number of processing lanes and/or exactly one data sink.

Other embodiments provide a variable numbers of each of the above.

Certain embodiments seek to provide at least one of or a subset of or all of the following operations:

a. Designing an architecture that allows
Arbitrary ingestion, processing, and data storage technologies in parallel; and/or
Arbitrary chaining of ingestion, processing, and data storage technologies.

b. Orchestrating an embodiment that features at least one of, or some of, or all of:
Auto-scaling data ingestion and processing
Programmable workflow management
Infrastructure-as-code configuration
Automated deployment

c. Selecting a set of ingestion and processing technologies that:
Cover the most relevant ingestion and analytics use cases and/or cover less relevant ingestion and analytics use cases

certain embodiments seek to provide a method, an apparatus, and computer program for a data ingestion and analytics platform including some or all of:
A data ingestion layer
A processing layer
A persistence layer
connectivity between the layers
data flow between the layers
deployment mechanism
Workflow mechanisms
Data ingestion mechanisms
Data processing mechanisms
Data storage mechanisms
Auto-scaling mechanisms
Availability and robustness mechanisms
Infrastructure as code mechanisms
Online monitoring.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A data processing system comprising:

At least one processing layer split into plural lanes operative for concurrent processing in accordance with different analytics requirements;

At least one initial data ingestion layer operative for ingestion of data and for routing the data to one of the plural lanes; and

A data storage layer aka persistence layer, receiving and storing outputs from the plural lanes,

wherein the lanes include:
a. a raw data pass-through lane which writes data received from the ingestion layer unaltered to the data storage layer;
b. a batch processing lane operative for batch processing of chunks of data received from the data storage layer;
c. a stateless stream processing lane to which data delivered as a stream of data packets is routed by the ingestion layer for stateless analytics performed for at least some of the packets, and wherein, in the stateless lane, scaling is achieved by distributing data routed to the stateless stream processing lane across more vs. less computational resources; and
d. a stateful stream processing lane to which data delivered as a stream of data packets is routed by the ingestion layer for stateful analytics and wherein in the stateful lane, scaling is achieved by distributing data streams across more vs. less computational resources while preserving each stream's integrity by assigning each given stream to only one resource.

According to alternative embodiments, any 1 or any 2 or any 3 of the 4 lanes described above, may be provided. For example, at least the following embodiments may be provided:

Embodiment i. A data processing system comprising:

At least one processing layer split into plural lanes operative for concurrent processing, using processor circuitry, in accordance with different analytics requirements;

At least one initial data ingestion layer operative for ingestion of data and routing data, using processor circuitry, to one of the plural lanes; and

A data storage layer aka persistence layer, receiving and storing outputs from the plural lanes,

wherein the lanes include at least one of:
at least one batch processing lane operative for batch processing, using processor circuitry, of chunks of data received from the data storage layer; and
at least one stream processing lane to which data delivered as a stream of data packets is routed by the ingestion layer for analytics performed, using processor circuitry, for at least some of the packets.

Embodiment ii. as in embodiment 1, and also comprising a raw data pass-through lane which writes data received from the ingestion layer unaltered to the data storage layer.

Embodiment iii. as in embodiment 1 or any embodiment herein, wherein the at least one batch processing line comprises a stateful batch processing lane and a stateless batch processing lane.

Embodiment iv. as in embodiment 1 or any embodiment herein, wherein the at least one stream processing line comprises a stateful stream processing lane to which data delivered as a stream of data packets is routed by the ingestion layer for stateful analytics and a stateless stream processing lane to which data delivered as a stream of data packets is routed by the ingestion layer for stateless analytics performed for at least some of the packets,.

Embodiment v. as in any embodiment herein wherein the system is generated in-factory for later installment.

Embodiment vi. as in embodiment iv or any embodiment herein, and wherein, in the stateless lane, scaling is achieved by distributing data routed to the stateless stream processing lane across more vs. less computational resources.

Embodiment v. as in embodiment iv or any embodiment herein and wherein in the stateful stream processing lane, scaling is achieved by distributing data streams across more vs. less computational resources while preserving each stream's integrity by assigning each given stream to only one resource.

Embodiment vi. as in embodiment iv or any embodiment herein and wherein in the stateless lane, scaling is achieved by distributing data routed to the stateless stream processing lane across more vs. less computational resources.

Embodiment vii. as in embodiment iii or any embodiment herein wherein data is routed by the ingestion layer to the stateless batch processing lane for stateless analytics and to the stateful batch processing lane for stateful analytics.

According to certain embodiments, only the lanes specifically stipulated in that embodiment are provided, and no other lanes, whereas conventional platforms are more general; typically allowing arbitrary streaming and batching environments. Especially when platforms E.g. spark and flunk are combined.

The stateful stream processing layer or lane may be substantially identical to the stateless stream processing layer other than holding state. It is appreciated that statelessness is advantageous since this facilitates horizontal scaling, yielding plural servers, without introducing dependencies between the plural servers.

Typically, all lanes' results may be re-used including even re-using lane a's result in lane a itself (or, of course, in any other). This may even be true for the raw data-pass-through lane, if useful in certain embodiments.

It is appreciated that stateless processing may if desired be processed in the stateful stream processing lane in which case the state is typically either empty or constant, such that stateless may be implemented as a special case of stateful e.g. because having no state may be regarded as having an always empty state which itself may be deemed a state.

It is appreciated that the term “shard” is intended to include streams with preserved integrity.

Generally, stateless processing scales well whereas stateful processing is more cumbersome to scale.

When concurrency or parallelism are provided between lanes, processing of data within the various lanes may be entirely independent of one another or may enjoy some degree of coordination.

Embodiment 2. A system according to any embodiment shown and described herein wherein the data storage layer is operative for feeding outputs from one of the lanes (lane L) back into lane L.

Embodiment 3. A system according to any embodiment shown and described herein wherein at least one of the stream processing lanes is operative to pre-process data thereby to generate pre-processed data, and to feed the pre-processed data back to the data ingestion layer.

Embodiment 4. A system according to any embodiment shown and described herein wherein the batch processing lane operates on at least one of a fixed-schedule or an on-demand schedule.

Embodiment 5. A system according to any embodiment shown and described herein wherein the Data ingestion layer receives incoming data packets from at least one of the following data feeds: a sensor, a smart phone, a social web, a general external application, and an external Analytics device which provides results extracted from raw data e.g. by (a) detecting people or other events in a raw data video stream sent to the device by a camera, using software analytics, and generating people present/absent results and/or by (b) detecting audio events in a raw-data audio stream sent to the device, using software analytics, and generating audio event present/absent results.

It is appreciated that external Analytics devices, typically embedded, may receive a raw data stream via conventional local communication from a co-located sensor e.g. camera, microphone or other IoT sensor and may detect events or classifications therein, such as (for audio) such as music, screaming, laughing, thereby to generate results which may then be sent by the device to the data ingestion layer, rather than sending the sensor's raw data e.g. complete audio or video stream. Example external analytics modules are IBM Watson, Google TensorFlow and any other suitable off-the shelf or proprietary modules. Examples of general external applications include Data Base Servers, Data Ingestion Systems, Cloud Based Applications.

Embodiment 6. A system according to any embodiment shown and described herein wherein the Data ingestion layer routes incoming data packets to lanes based on at least one packet attribute, the attribute characterizing at least one of the packet's content and the packet's origin.

It is appreciated that data packets, each typically comprising a set of data points sent together, do not necessarily have attributes defined as packet-level metadata. However, data packet attributes may, if not defined at packet-level, be taken from one or more of the data points within the data packet.

Embodiment 7. A system according to any embodiment shown and described herein wherein the data comprises IoT data.

Embodiment 8. A system according to any embodiment shown and described herein wherein herein the concurrent processing comprises parallel processing including coordination between the lanes including time syncing where data stemming from the same time is processed at the same time such that data points within the different lanes always have the same time-stamp because faster lane/s wait/s for slower lane/s.

Embodiment 9. A system according to any embodiment shown and described herein wherein outputs from the plural lanes are fed back to the at least one processing layer.

Embodiment 10. A system according to any embodiment shown and described herein wherein the stateless analytics are performed asynchronously for at least some of the packets.

Embodiment 11. A system according to any embodiment shown and described herein wherein at least one of the lanes is cloned for scaling.

According to certain embodiments, there is no need to clone a lane for scaling purposes, since the lane may be scaled by providing more resources thereto.

According to certain embodiments, for a stateful processing lane, cloning is deemed more complicated than providing more resources to a single copy, as state requirements are to be obeyed.

Embodiment 12. A system according to any embodiment shown and described herein wherein the distributing which achieves scaling is performed by the data ingestion layer which groups incoming data based on content.

Embodiment 13. A system according to any embodiment shown and described herein wherein the data ingestion layer groups incoming sensor data provided by plural sensors each associated with a unique identifier, based at least partly on the unique identifier.

Embodiment 14. A system according to any embodiment shown and described herein wherein the data ingestion layer groups incoming data based on a distribution key provided by a data base table.

Embodiment 15. A system according to any embodiment shown and described herein wherein the data storage layer is operative for feeding outputs from a first one of the lanes into a second one of the lanes.

Embodiment 16. A system according to any embodiment shown and described herein wherein the data storage layer is operative for feeding at least raw data from the pass-through lane to the batch processing lane.

Embodiment 17. A system according to any embodiment shown and described herein wherein the data storage layer is operative for feeding at least analytics results generated by at least one of the stream processing lanes, to the batch processing lane.

Embodiment 18. A system according to any embodiment shown and described herein wherein the lanes include at least one lane that operates on individual data points.

Embodiment 19. A system according to any embodiment shown and described herein wherein the ingestion layer performs at least one of Authentication and Anonymization.

Embodiment 20. A system according to any embodiment shown and described herein wherein the Scaling includes cloning the stateful stream processing lane according to shards, the cloning according to shards being characterized in that each assigned shard is assigned in its entirety to a single clone.

Embodiment 21. A system according to any embodiment shown and described herein wherein the raw data pass-through lane is scaled horizontally.

Embodiment 22. A system according to any embodiment shown and described herein wherein the raw data pass-through lane is scaled vertically.

Embodiment 23. A system according to any embodiment shown and described herein wherein the batch processing lane is scaled horizontally.

Embodiment 24. A system according to any embodiment shown and described herein wherein the batch processing lane is scaled vertically.

It is appreciated that scaling vertically includes replacing a server with a given processing speed, with a faster aka bigger server having a greater processing speed whereas scaling horizontally means adding servers. Horizontal scaling is usually efficient but adds complexity in coordinating work between plural servers e.g. by keeping the work each server performs or each server's processing, independent of the processing performed by other servers as much as possible e.g. by maintaining statelessness which facilitates horizontal scaling without introducing dependencies. In the stateful stream processing lane however, logic may be added to coordinate distribution of work and recover from failures.

Embodiment 25. A system according to any embodiment shown and described herein wherein at least one analytics result from at least one stream processing lane, provided by the data storage layer, is used as an input to the stateful stream processing lane.

Embodiment 26. A system according to any embodiment shown and described herein wherein at least one analytics result from at least one stream processing lane, provided by the data storage layer, is used as an input to the stateless stream processing lane.

Embodiment 27. A system according to any embodiment shown and described herein wherein the stateless analytics is performed asynchronously for at least some of the packets.

the term “asynchronously” is intended to include:
i. that analytics on packet P need not be finished on a lane L e.g. on the stateless stream processing lane, before the next data packet P+1 is sent into the lane L such that at least one packet P+1 is sent into lane L before the lane L has completed analytics on packet P that preceded P+1 in the lane L; and/or
ii. that no order is assumed by the analytics to exist, between packets on a lane L .g. on the stateless stream processing lane which are undergoing the analytics. for example, the analytics do not assume that the packets travel along lane L .g. the stateless stream processing lane in the order the packets arrived at the system.

Embodiment 28. A data processing method comprising:

In at least one processing layer split into plural lanes, performing concurrent processing e.g. in accordance with plural analytics requirements respectively;

In at least one initial data ingestion layer performing ingestion of data and routing the data to one of the plural lanes; and

In a data storage layer aka persistence layer, receiving and storing outputs from the plural lanes,

wherein the lanes include:
a. a raw data pass-through lane which writes data received from the ingestion layer unaltered to the data storage layer;
b. a batch processing lane operative for batch processing, using processor circuitry, of chunks of data received from the data storage layer;
c. a stateless stream processing lane to which data delivered as a stream of data packets is routed by the ingestion layer for stateless analytics, using processor circuitry, performed for at least some of the packets, and wherein, in the stateless lane, scaling is achieved by distributing data routed to the stateless stream processing lane across more vs. less computational resources; and
d. a stateful stream processing lane to which data delivered as a stream of data packets is routed by the ingestion layer for stateful analytics, using processor circuitry, and wherein in the stateful lane, scaling is achieved by distributing data streams across more vs. less computational resources while preserving each stream's integrity by assigning each given stream to only one resource.

Embodiment 29. A computer program product, comprising a non-transitory tangible computer readable medium having computer readable program code embodied therein, the computer readable program code adapted to be executed to implement a data processing method comprising:

In at least one processing layer split into plural lanes, performing concurrent processing e.g. in accordance with plural analytics requirements respectively;

In at least one initial data ingestion layer performing ingestion of data and routing the data to one of the plural lanes; and

In a data storage layer aka persistence layer, receiving and storing outputs from the plural lanes,

wherein the lanes include:
a. a raw data pass-through lane which writes data received from the ingestion layer unaltered to the data storage layer;
b. a batch processing lane operative for batch processing of chunks of data received from the data storage layer;
c. a stateless stream processing lane to which data delivered as a stream of data packets is routed by the ingestion layer for stateless analytics performed for at least some of the packets, and wherein, in the stateless lane, scaling is achieved by distributing data routed to the stateless stream processing lane across more vs. less computational resources; and
d. a stateful stream processing lane to which data delivered as a stream of data packets is routed by the ingestion layer for stateful analytics and wherein in the stateful lane, scaling is achieved by distributing data streams across more vs. less computational resources while preserving each stream's integrity by assigning each given stream to only one resource.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer -usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and /or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIGS. 1a, 1b aka FIGS. 2.1, 2.2 respectively are diagrams useful in understanding certain embodiments of the present invention.

FIGS. 2a, 2b aka Tables 3.1, 3.2 respectively are tables useful in understanding certain embodiments of the present invention.

FIGS. 3a-3c aka FIGS. 3.1, 3.2, 4.1 respectively are diagrams useful in understanding certain embodiments of the present invention.

FIGS. 4a, 4b , . . . 4h aka Tables 5.1-5.8 respectively are tables useful in understanding certain embodiments of the present invention.

FIGS. 5a b c aka listings 5.1, 6.1, 6.2 respectively are listings useful in understanding certain embodiments of the present invention.

FIGS. 6a-6e aka FIGS. 5.1-5.5 respectively are diagrams useful in understanding certain embodiments of the present invention.

FIGS. 7a-7d aka FIGS. 6.1-6.4 respectively are diagrams useful in understanding certain embodiments of the present invention.

In particular:

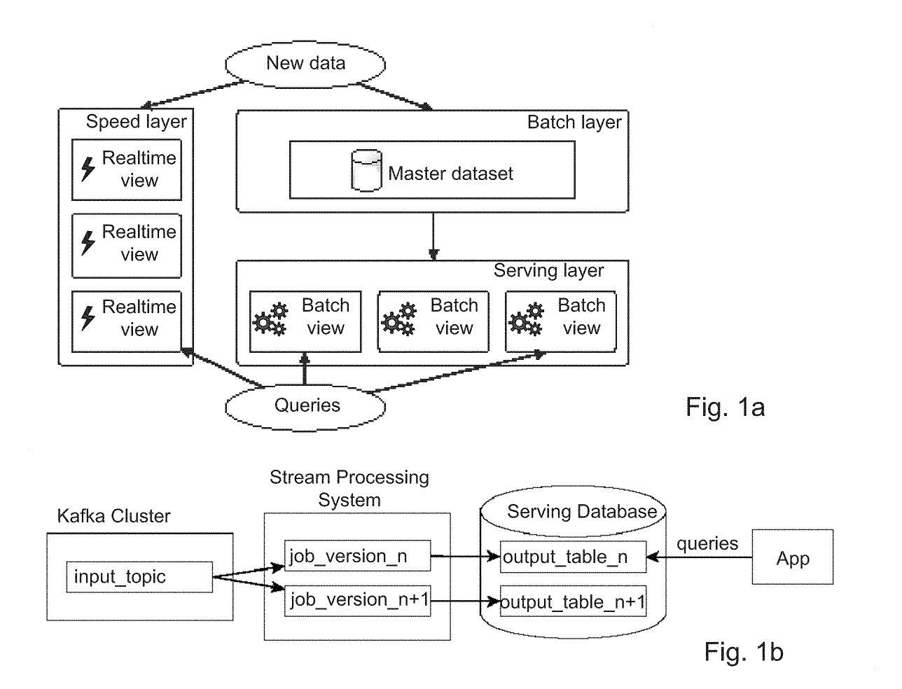

FIG. 1a illustrates a Lambda Architecture;

FIG. 1b illustrates a Kappa Architecture;

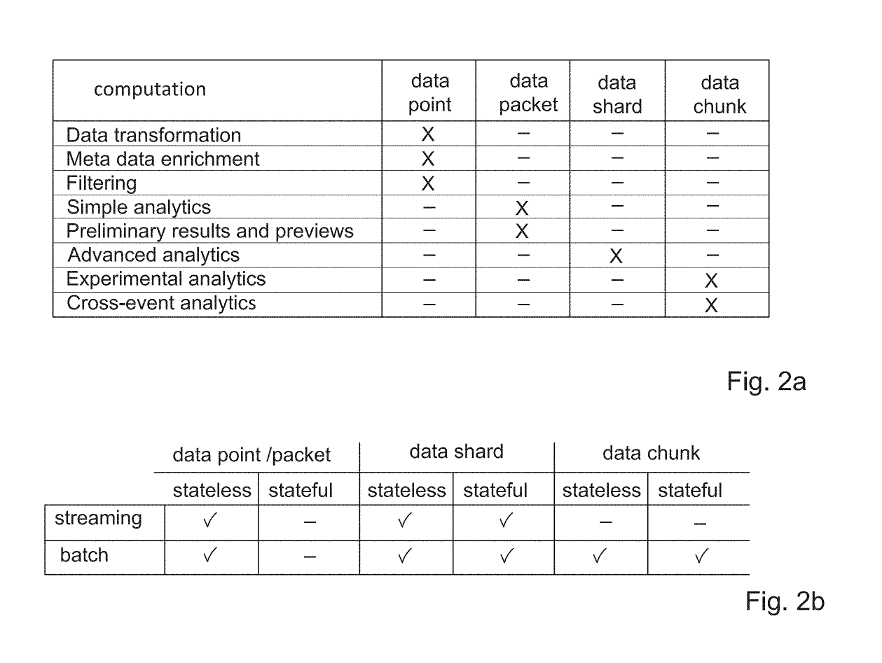

FIG. 2a is a table aka table 3.1 presenting data requirements for different types of use cases;

FIG. 2b is a table aka table 3.2 presenting capabilities of a platform supporting the four base classes;

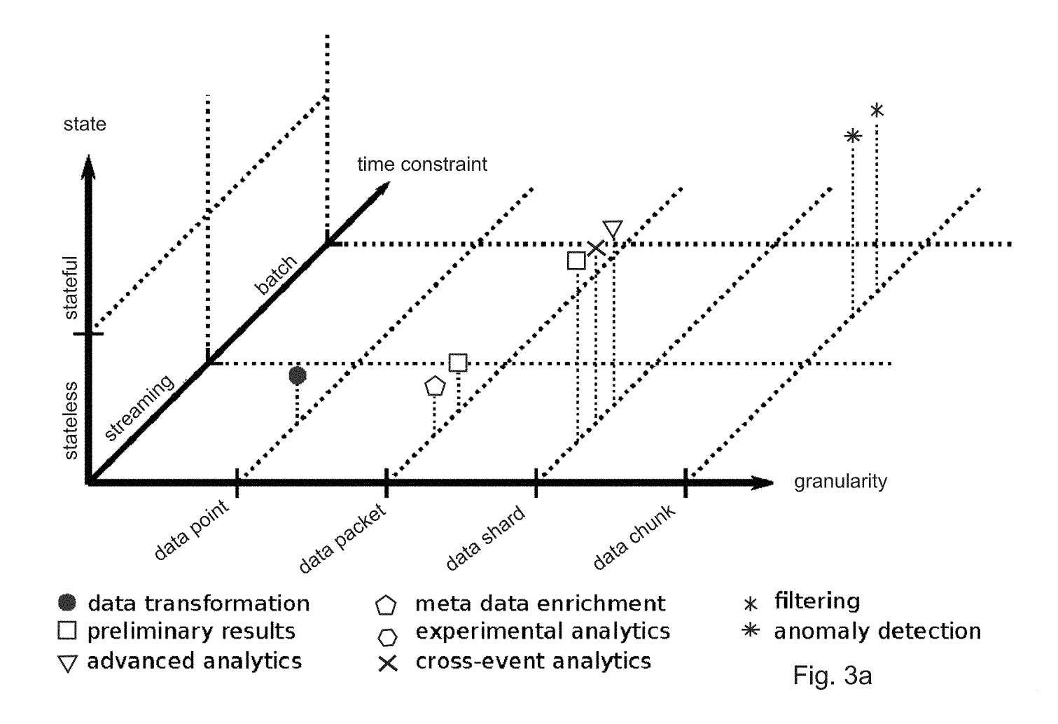

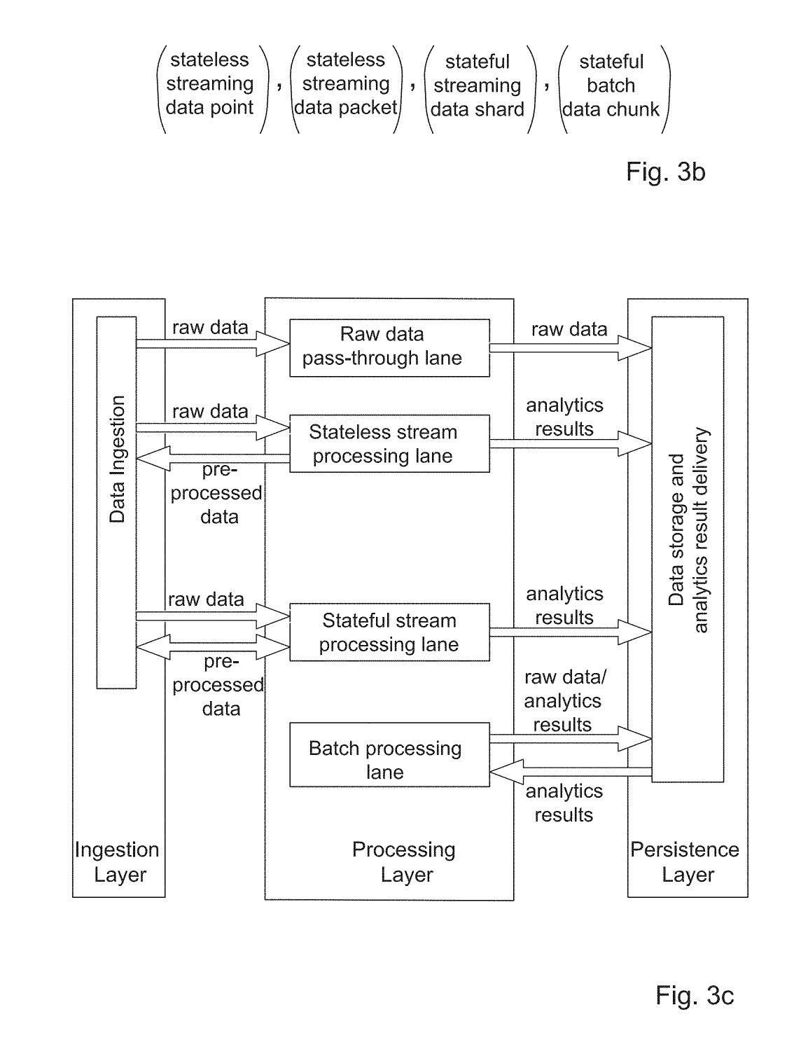

FIG. 3a illustrates dimensions of the computations performed for different use cases;

FIG. 3b illustrates Vector representations of analytics use cases;

FIG. 3c illustrates a high level architectural view of the analytics platform;

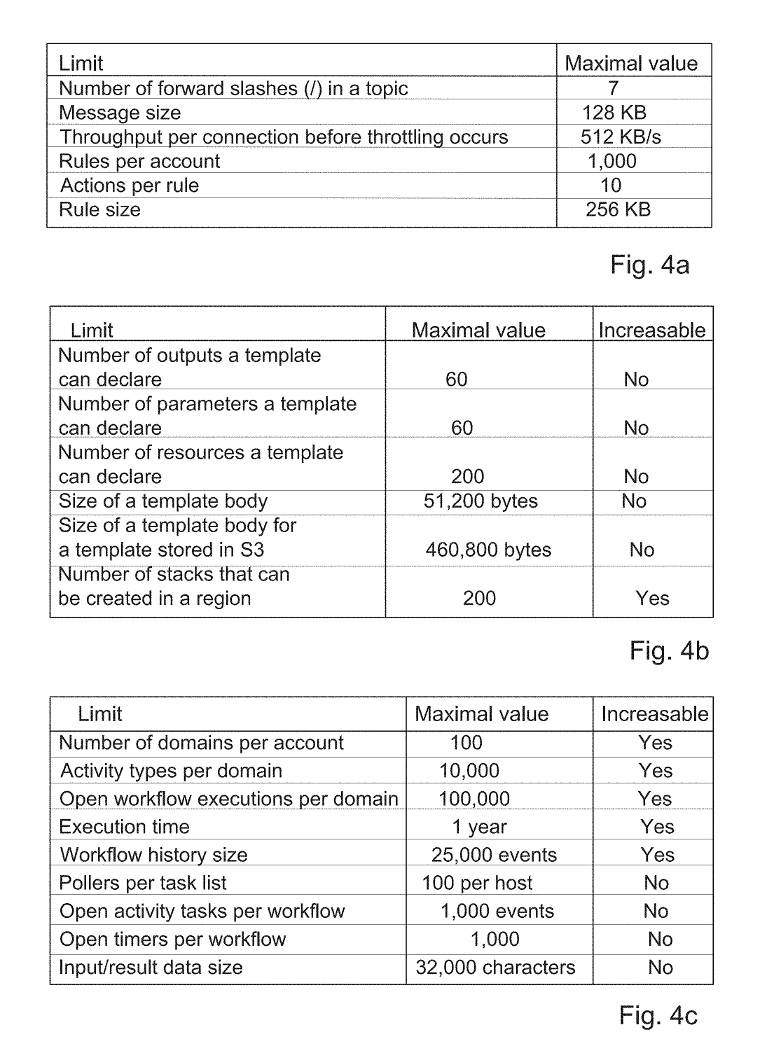

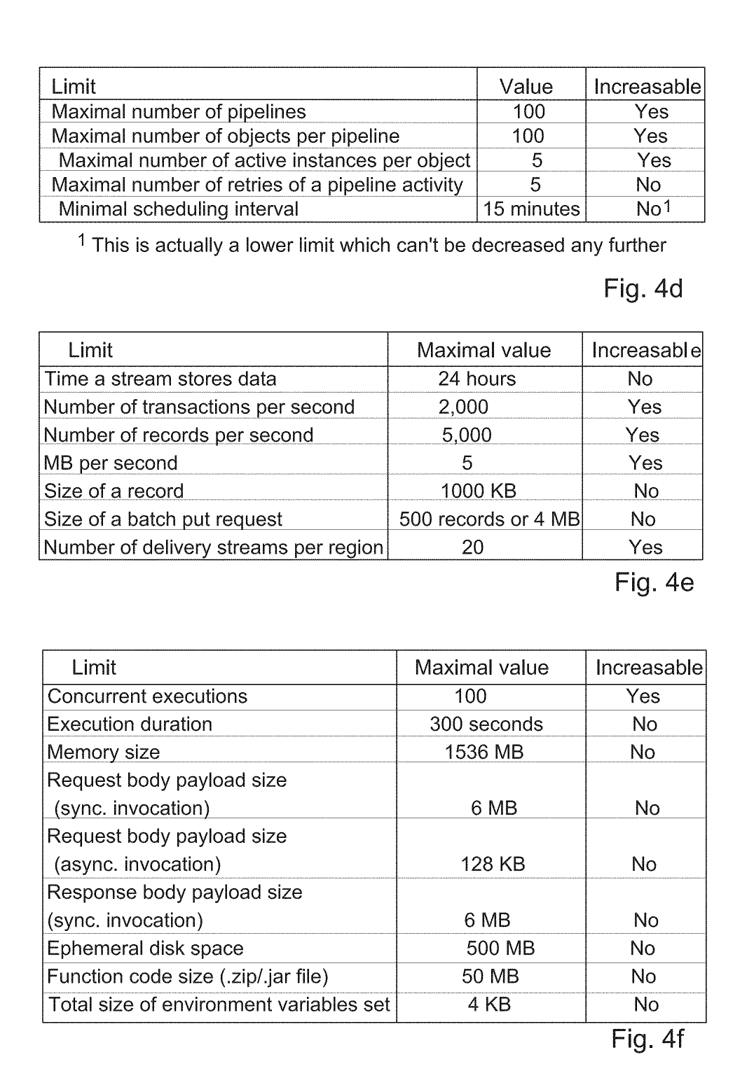

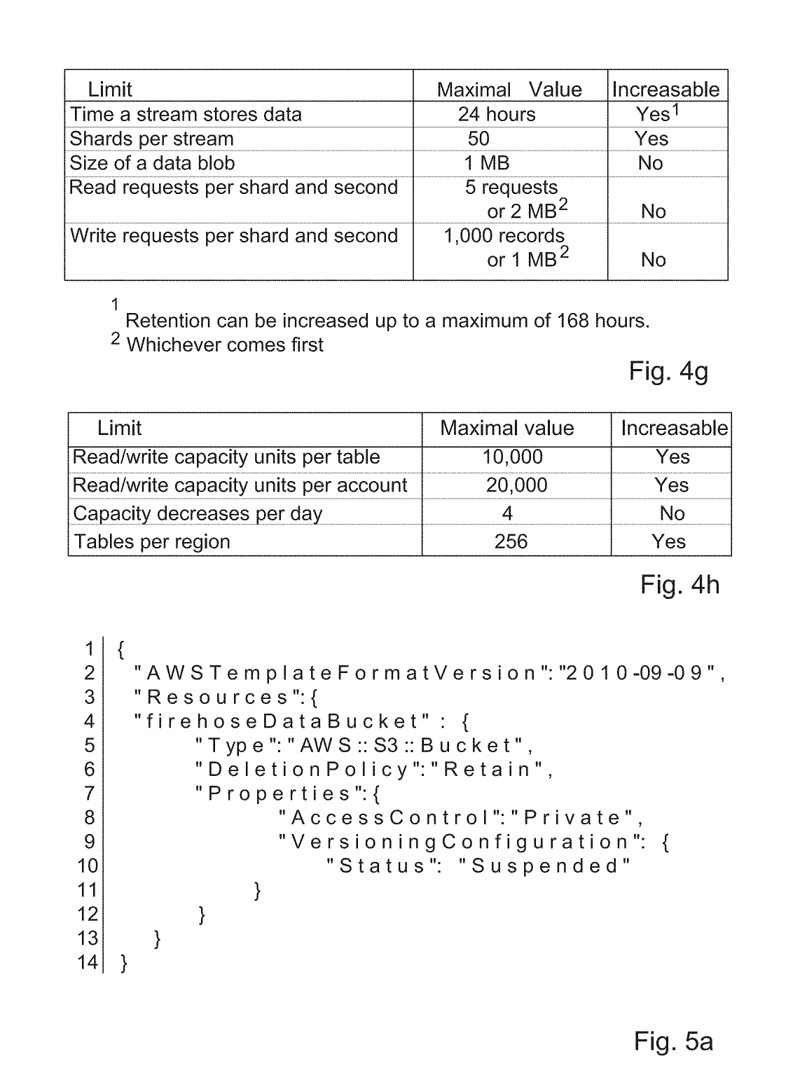

FIG. 4a is a table aka table 5.1 presenting AWS IoT service limit

FIG. 4b is a table aka table 5.2 presenting AWS Cloud Formation service limits;

FIG. 4c is a table aka table 5.3 presenting Amazon Simple Workflow service limits;

FIG. 4d is a table aka table 5.4 presenting AWS Data Pipeline service limits;

FIG. 4e is a table aka table 5.5 presenting Amazon Kinesis Firehose service limits;

FIG. 4f is a table aka table 5.6 presenting AWS Lambda service limits;

FIG. 4g is a table aka table 5.7 presenting Amazon Kinesis Streams service limits;

FIG. 4h is a table aka table 5.8 presenting Amazon DynamoDB service limits;

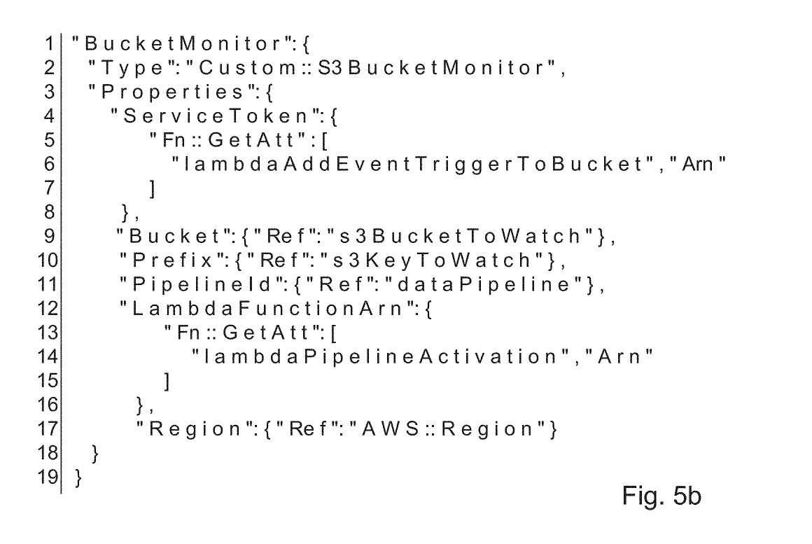

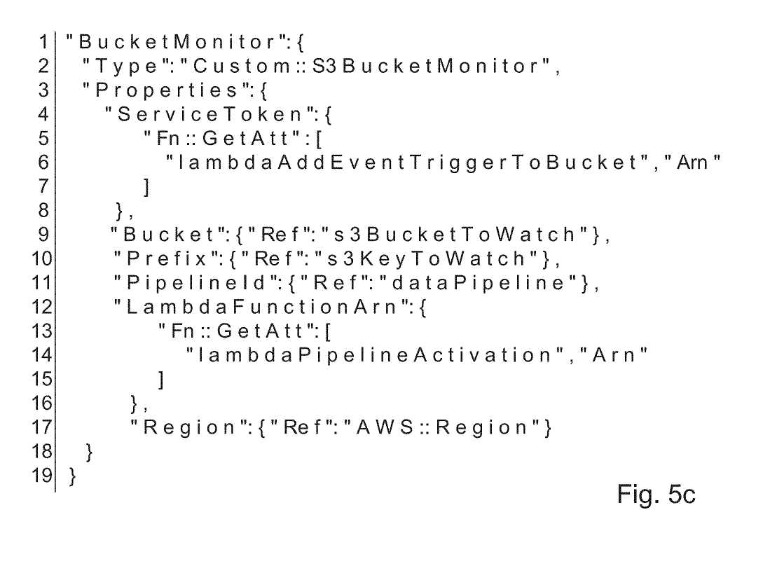

FIG. 5a aka Listing 5.1 is a listing for Creating an S3 bucket with a Deletion Policy in Cloud Formation;

FIG. 5b aka Listing 6.1 is a listing for Creating an AWS IoT rule with a Firehose action in Cloud Formation; and

FIG. 5c aka Listing 6.2 is a listing for BucketMonitor configuration in Cloud Formation.

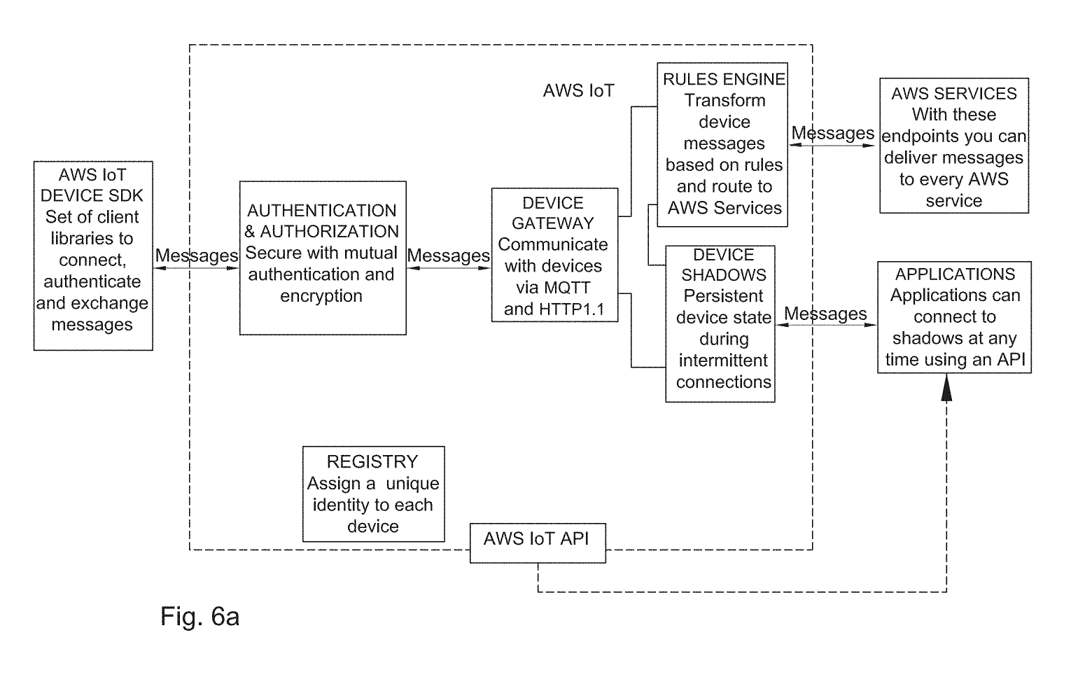

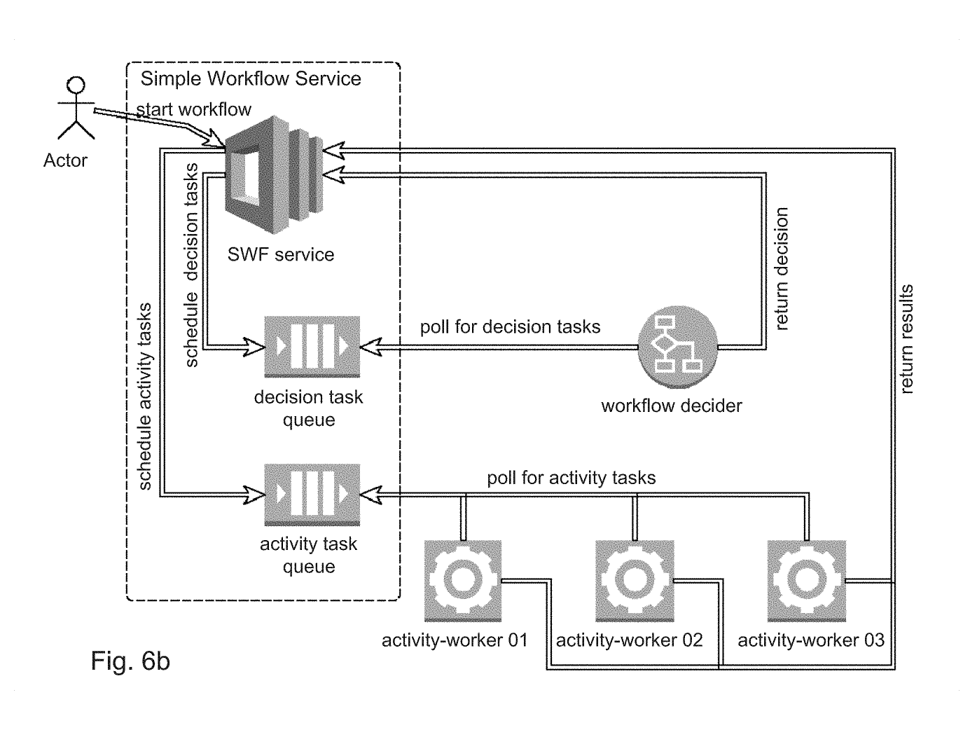

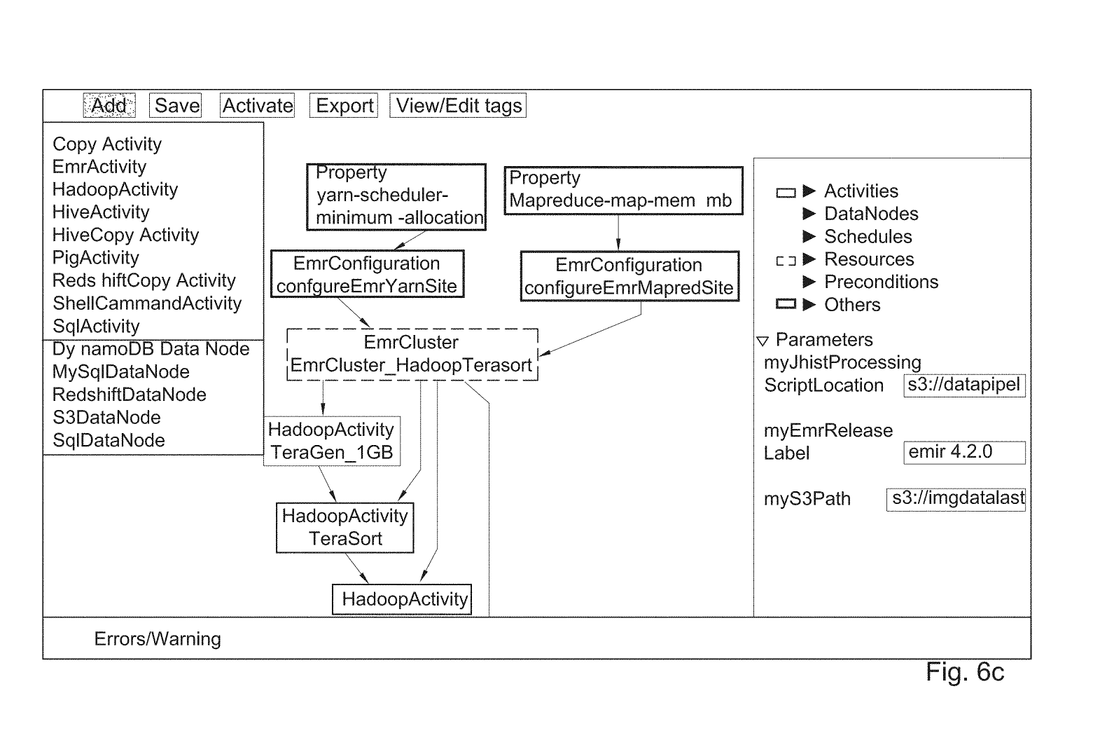

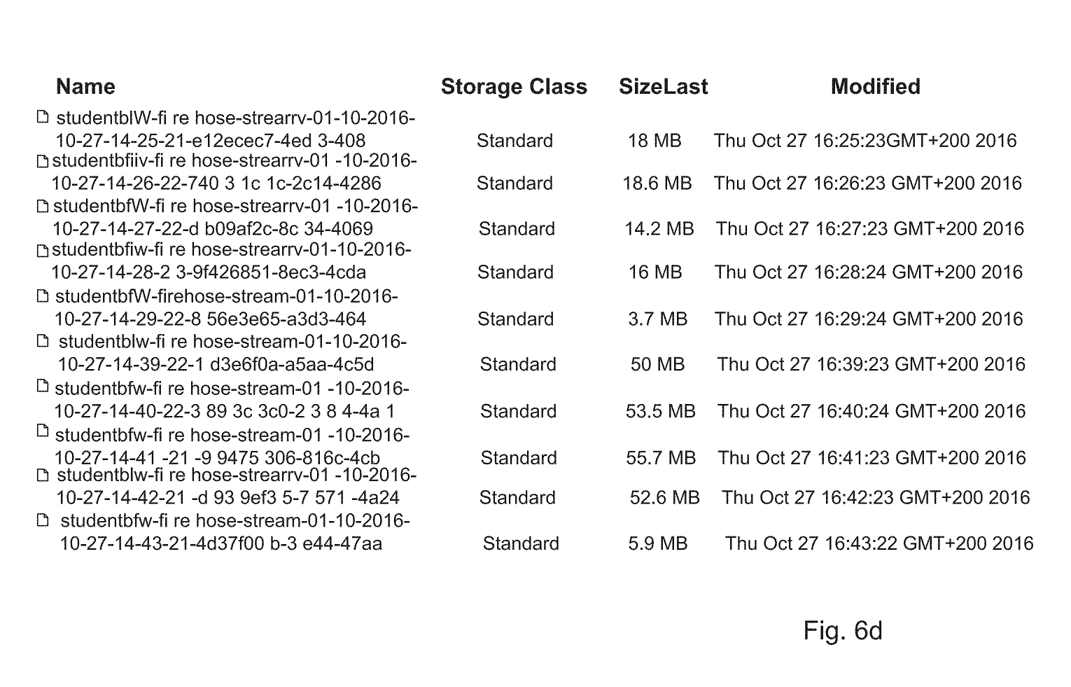

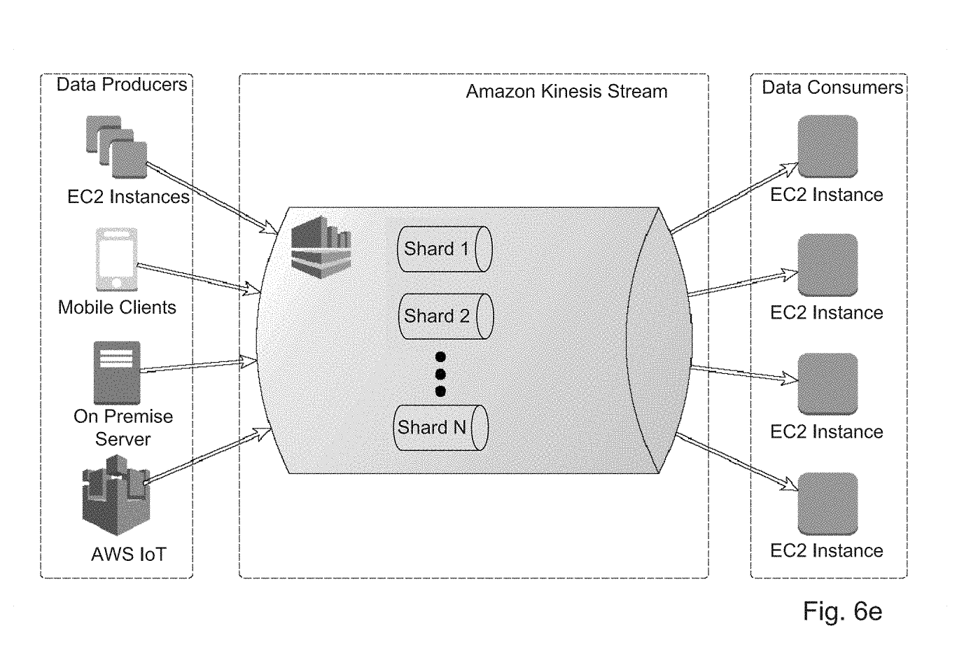

FIG. 6a illustrates an overview of AWS IoT service platform;

FIG. 6b illustrates basic control flow between SWF service, decider and activity workers;

FIG. 6c illustrates a screenshot of AWS Data Pipeline Architecture;

FIG. 6d illustrates a S3 bucket with folder structure and data as delivered by Kinesis Firehose;

FIG. 6e illustrates an Amazon Kinesis stream high-level architecture;

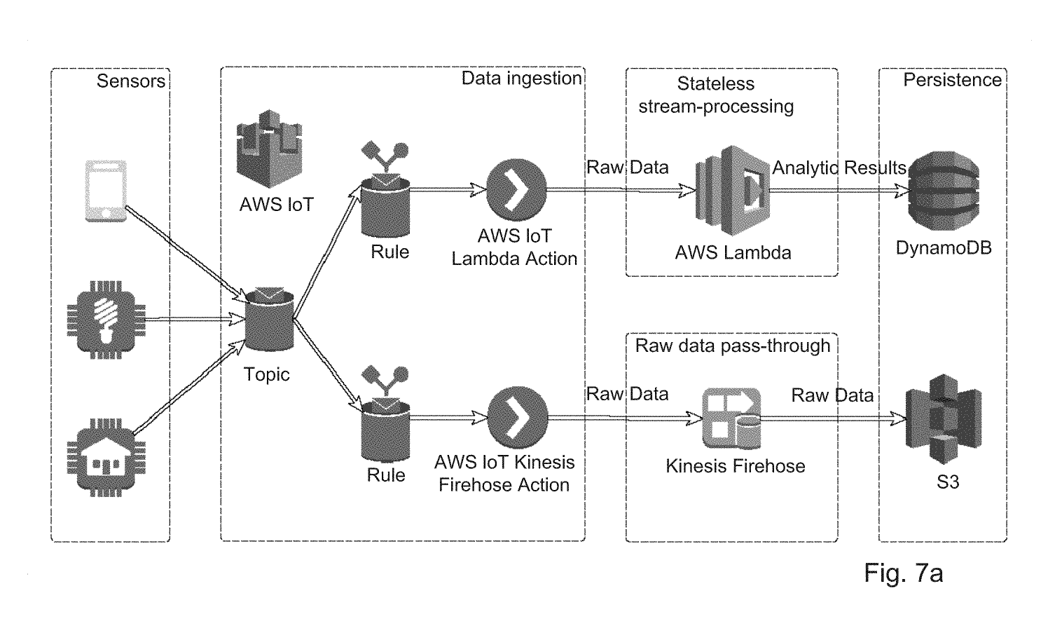

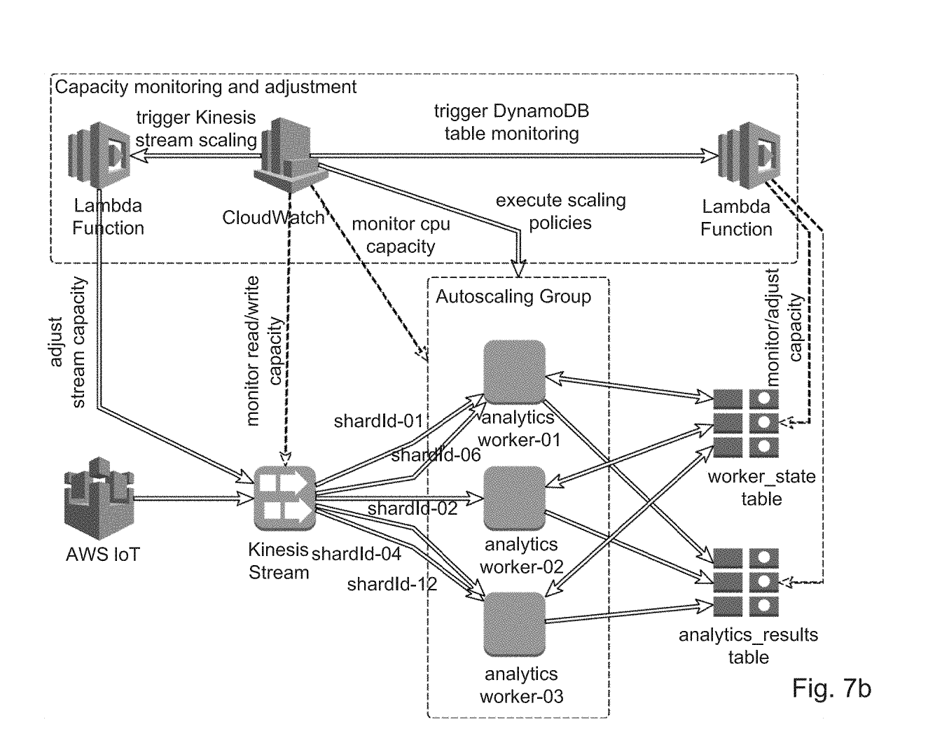

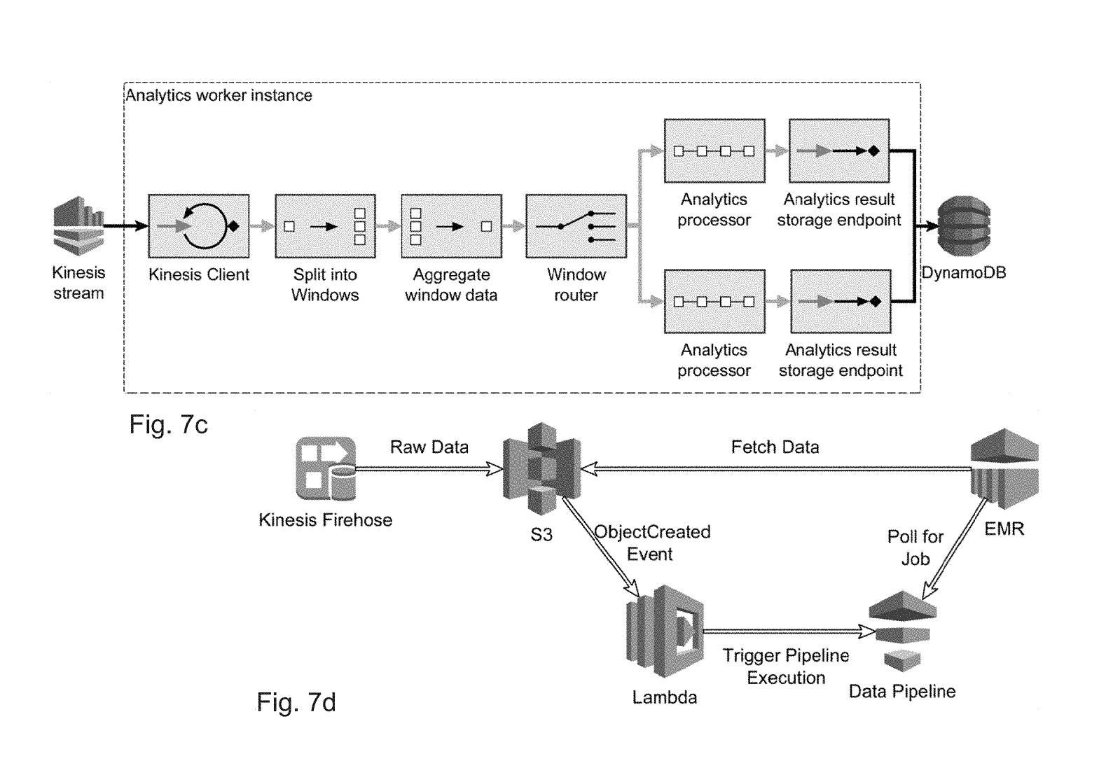

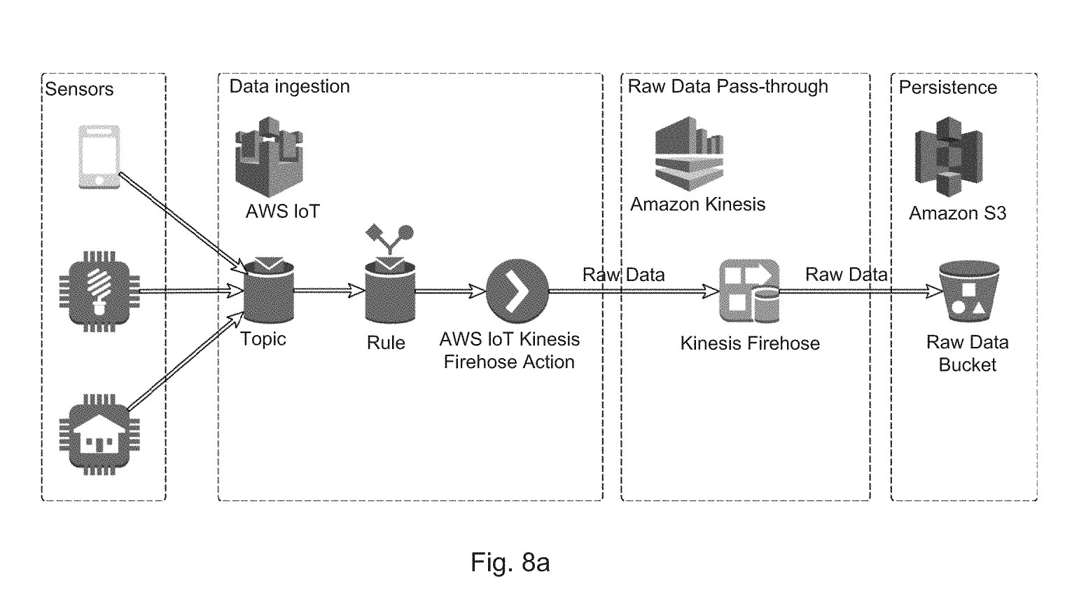

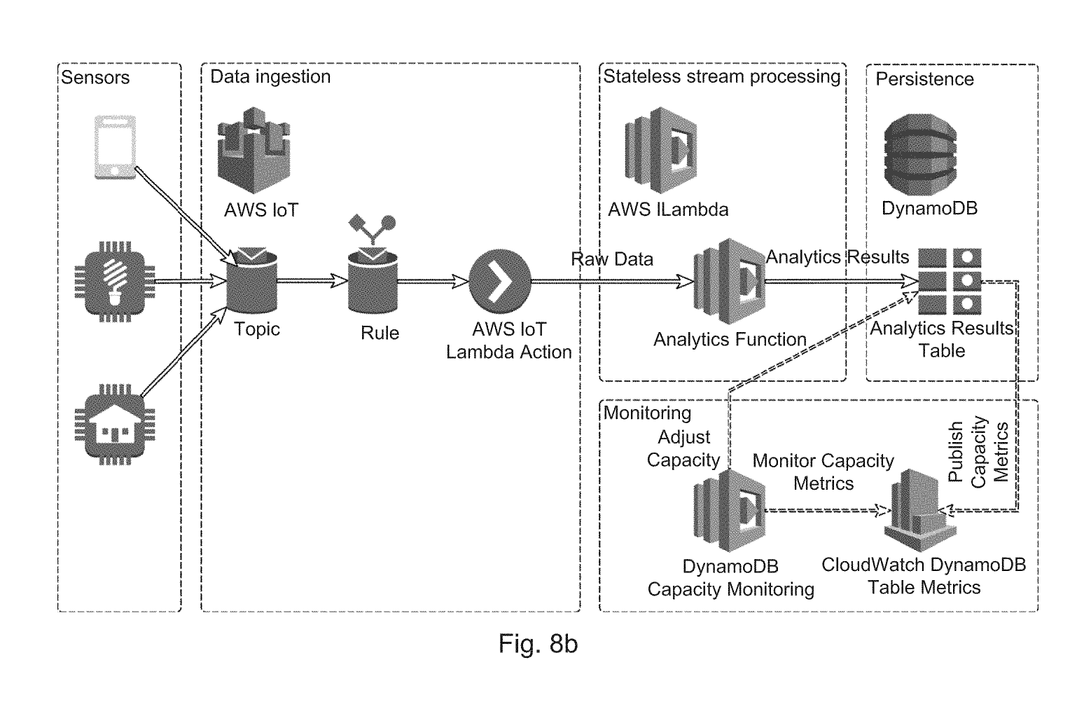

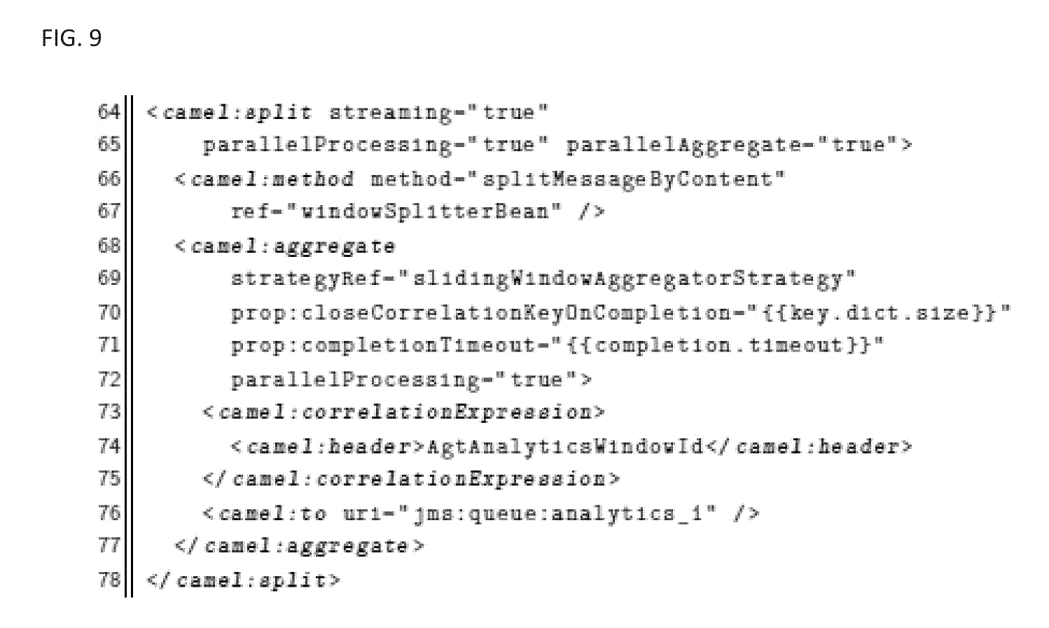

FIG. 7a illustrates a platform with stateless stream processing and raw data pass-through lane;

FIG. 7b illustrates an overview of a stateful stream processing lane;

FIG. 7c illustrates a schematic view of a Camel route implementing an analytics workflow;

FIG. 7d illustrates a batch processing lane using on demand activated pipelines;

FIGS. 8a, 8b are respective self-explanatory variations on the two-lane embodiment of FIG. 7a (raw data passthrough and stateless online analytics lanes respectively).

FIG. 9 is a listing useful in understanding certain embodiments of the present invention.

Methods and systems included in the scope of the present invention may include some (e.g. any suitable subset) or all of the functional blocks shown in the specifically illustrated implementations by way of example, in any suitable order e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software, firmware, hardware or any combination thereof. Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case some or all of the variables, parameters, and computations described herein may be in hardware.

Any module or functionality described herein may comprise a suitably configured hardware component or circuitry e.g. processor circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

The process of generating insights from Internet of Things (IoT) data, often referred to with the buzzwords IoT and Big Data Analytics, is one of the most important growth markets in the information technology sector [78]; it is appreciated that square-bracketed numbers herewithin refer to teachings known in the art which according to certain embodiments may be used in conjunction with the present invention as indicated, where the respective teachings is known inter alia from the like-numbered respective publication cited in the Background section above. The importance of data as a future commodity is growing [73]. All major cloud service providers offer products and services to process and analyze data in the cloud.

IoT analytics require adaptable infrastructures and flexible workflows that can be setup fast and automated with a high level of customizability. Certain embodiments herein implement an architecture using a selection of building blocks to achieve this effectively yielding a foundation platform applicable to various data ingestion and analytics situations.

(Social) IoT data ingestion & analytics demand infrastructures which are flexible in the sense of effectively dealing with highly varying data rates, data granularities, time constraints, analytic approaches, workflows, state requirements, resource usage, high availability, and almost arbitrary use cases while providing fast setup times, code maintainability, deployment manageability and online monitoring. Conventional infrastructures do not have this flexibility. Certain embodiments seek to provide a reference architecture, platform, and selection of suitable building blocks.

The process of generating insights from sensor and (social) media data, or IoT or Big Data Analytics, is an most important information technology characterized by some or all of the following:
high variation in the incoming data rates that have to be processed.
Varying granularity of the processed data reaching from stream processing on individual data points to batch processing of entire historic data archives; with, say, a couple of gradations in between.
Variable requirements regarding the time constraints imposed on the provisioning of the results reaching from real-time to best effort; with, say, a couple of gradations in between.
Support for different types of use cases and analytics.
Flexible and easy to implement workflow management.
The need to support both stateful and stateless processes.
The respective analytics require substantial networking, storage, and compute resources which have to be carefully sized and provisioned to provide the indicated performance.
High availability and robustness.
Setup, deployment and management of the infrastructure in different flavors meeting different use cases within a narrow time frame.
Code maintainability of the infrastructure allowing for easy bug fixing and feature addition.
Easy deployment management.
Online monitoring of the infrastructure.

While some description herein uses, for clarity, the example of data ingestion and analytics in AWS-based (Social) IoT situations, it is appreciated that applicability is intended to include other data and resource intensive use cases, such as machinery analytics and traffic analytics or completely different data-heavy realms such as, say, genome sequencing. applicability is intended to include also other infrastructure settings such as different Cloud providers or even on-premise clusters.

A high-level view of platform architecture according to certain embodiments is shown in FIG. 4.1 aka FIG. 3c. typically, three layers are provided, responsible for ingestion, processing and storage of data respectively. The middle processing layer is split into plural (e.g. including some or all of the four lanes illustrated) to accommodate different analytics requirements. Arrows denote possible directions and types of data flow between the components making up the layers.

The data ingestion layer is the layer interfacing the outside world. Analytics running on premises, sensors and smart phones may send their collected data to this layer. Inside the layer incoming data packets are routed to specific lanes in the processing layer based on each packet's content and/or origin e.g. a unique identifier of a sensor or other device which provided the data. This layer may include an authentication mechanism to prevent unauthorized submission of data. If data is to be anonymized before processing or storage conventional anonymization may also be performed inside this layer.

In the Data processing layer, actual analytics are executed. Because of the differences in the requirements of the analytics this layer may be split into plural, e.g. as shown three, lanes. The bottom three lanes may for example correspond with the analytics classes for data packets, data shards and data chunks as defined herein and there may be no separate lane for processing data points which are, instead, treated as data packets containing only a single data point and routed to and processed in the data packet lane. A lane may be added to send incoming data to the persistence layer without any processing e.g. for archiving and processing in the batch processing lane. The Raw data pass-through lane typically writes the data it receives from the ingestion layer unaltered to the persistence layer. It has no processing capability and can require only very minimal setup.

The Stateless stream processing lane provides maximum speed and maximum concurrency relative to other lanes. The delay from data ingestion to analytics completion may for example be in the range of milliseconds to a second in this lane. To achieve this the granularity of analytics performed in this lane is limited to data delivered in a single data packet. Additionally all analytics performed in this lane are required to be stateless allowing data packets to be processed completely asynchronously hence with maximum concurrency. Since there are no data dependencies scaling can be achieved by distributing the data across more computation resources. Typically, use of pre-established models e.g. in anomaly detection is not considered as a state as long as the model is not updated during the computation performed by the lane. Possible applications for this lane include one or more of simple transformations of data formats or units, such as converting data from a proprietary binary format to json, or converting Celcius temperature values to Fahrenheit, filtering of values or anomaly detection, or supplying commentators or spectators of events with live analytics or populating dashboards with preliminary values or other transformations of similarly low complexity. According to certain embodiments, other, slower, lanes may fill in missing results, missed by this lane, or correct errors made by this lane, at a later point in time.

In contrast the stateful stream processing lane offers stateful analytics and typically supports accumulation of data from multiple requests and/or uses previous analytics results as an input. All computations are typically performed on independent streams of data to allow concurrent or parallel processing of multiple streams. Scaling may be accomplished by spreading streams across more computational resources while preserving each stream's integrity e.g. by evaluating the content of the data packets in the stream, typically using unique sensor id's to differentiate information from different sensors, e.g. as described herein. An application may include activity recognition performed on data gathered by wristbands of a crowd attending an event. analytics can be performed for each person individually since Data from other persons' wristbands is not required. However this is not necessarily limited to a single device. An independent data set might also be obtained from sensors installed in a single household or a single machine. The lane can work with data processed previously in either one of the stream processing lanes.

The batch processing lane is operative to process large amounts of any kind of data in batches. Typically there are in this lane no restrictions on dependencies between the processed data sets. The lane typically executes computations on a fixed schedule or on demand. The lane typically supports applications like model learning which are typically long-running processes executed on occasion e.g. at regular intervals on large amounts of data. Other applications which may be routed to this lane, according to any suitable logic, are redoing the analytics of the stream processing lane using either computationally more expensive analytics than the stream processing lane, or more data than the stream processing lane, to improve results obtained by the stream processing lane. This may involve including data that has been left out previously, when the stream processing lane operated on this data set, and/or integrating data from other sources.

Batch processing can be done on raw data as well as on results of other processing lanes if such results are available from the persistence layer.

The persistence layer typically is operative for some or all of the following three functions or usage situations:

a. provides long-term storage for the raw data as it comes in via the pass-through lane.

b. stores analytics results and makes them available for other uses.

c. makes raw data and analytics results available for batch processing.

The persistence layer may comprise plural storage technologies such as but not limited to any or any combination of: large block storage, like S3 for raw data storage, key-value stores and relational databases, like DynamoDB, Redis, or MySQL, for caching of intermediate results and results serving, to accommodate all of the above.

Any suitable services and technologies may be used to implement each area of the platform, typically selecting based on using cloud services where possible and based on services provided, scalability and limitations on requirements of the platform suitable for a system managed by a cloud provider and scaled automatically. For example, regarding Deployment, deploying the platform manually is error prone and time consuming and therefore, an infrastructure as code approach is typically employed. Amazon supports this in the form of the CloudFormation service. alternatives available that also offer support for the AWS cloud are Ansible or Puppet, products which focus on automatic provisioning and setup of servers and the surrounding services. Ansible supports deployment of CloudFormation templates using the AWS service and this may be suitable if it is desired to transition from CloudFormation to Ansible.

According to one embodiment, AWS CloudFormation service is used to handle creation of resources and deployment of platform components.

Regarding Data ingestion e.g. the data ingestion layer of FIG. 4.1, AWS IoT may be used, being scalable and robust, well integrated with many other services and operative to route a single data packet to multiple destinations without programming a single line of code.

Regarding the Raw data pass-through lane, Kinesis Firehose may be used, being operative to auto scale up to an account limit while being used and incurring no fees when idle. The minimal configuration requires only a delivery destination and may be integrated with AWS IoT by using the rules engine and Firehose action.

The Stateless stream processing lane typically performs lightweight and fast stateless analytics only, hence AWS Lambda functions may be used. The Lambda service auto scales up to the account limit and can execute up to that many instances of the analytics function in parallel. Lambda is also integrated with AWS IoT via the rules engine and the Lambda action. Analytics results may be written to DynamoDB by default. the DynamoDB service does not auto scale but an additional Lambda function may be used to monitor the used write and read capacity units and adjust provisioned capacity of the table.

The Stateful stream processing lane performs analytics which may require previous data packets. the analytics may use sliding or tumbling window views of the incoming data stream as input. analytics may also require at least one previous result. It is appreciated that Analytics using previous results typically requires synchronization to ensure analytics performed on the data of time slot C does not end up using the results of time slot A e.g. if the result for time slot B (which falls temporally between time slots a, c) is not yet available. In Sliding window analytics, data belonging to each window typically must be aggregated somewhere. It is typically desired that scaling-up or down should not violate integrity of a data shard. All packets belonging to a shard are typically redistributed as a unit.

Typically, in the Stateful stream processing lane as opposed to the stateless processing lane, analytics cannot be triggered by advent of a new data packet. Instead an scheduling module is typically provided for scheduling analytics and flow of data between analytics operations.

To achieve all of the above for the Stateful stream processing lane, and provide auto scalability, Amazon Kinesis Streams may be used to gather and partition data and/or EC2 instances in an auto scaling group may be used to perform the lane's analytics. Since Kinesis is integrated with AWS IoT, writing thereto may be achieved by, typically, simple configuration. If the partition key is selected such that all data belonging to a particular shard is assigned to the same partition in the stream this guarantees each shard will be delivered to the correct worker instance. Each of the resulting partitions may be assigned to an EC2 instance executing the analytics. In the worker instance Apache Camel, a message routing system, may handle delivery of data to each analytics operation and the assembly of analytics windows (https://camel.apache.org/). In Apache Camel the flow of data and type of executed analytics can be changed without needing to modify XML files for programming purposes.

The batch processing lane processes data stored in the persistence layer e.g. data may be stored in S3. The Data Pipeline service in combination with Amazon EMR may be used to implement this lane. It is appreciated that alternatively, another service may be employed which preferably like the Data Pipeline service is characterized by any subset or all of:
pipelines can be executed on a schedule or on demand using Lambda
EC2 instances and EMR clusters can be provisioned on demand
A visual designer to create workflows is provided such that no human programming skills are required
EMR clusters can be shared between multiple pipelines e.g. using TaskRunner
unlike with Azkaban, Airflow or Luigi no additional infrastructure is required
using Oozie workflows in addition to Data Pipeline remains an option.

The persistence layer is typically operative to provide persistent storage for the incoming raw data, the results of the analytics lanes. S3 may be used for archiving raw data and making data available to the batch processing lane. DynamoDB may be used as a results serving database. However these are, of course, merely examples and storage technologies employed, such as but not limited to any or any combination of: large block storage, like S3 for raw data storage, key-value stores and relational databases, like DynamoDB, Redis, or MySQL, for caching of intermediate results and results serving, typically depends on the use case.

An example implementation of the analytics lanes of the platform using the above-described technologies and services, is now described in detail. The Raw data pass-through lane may consist only of services which no additional code to deploy. For example, only one rule and an action need be configured in AWS IoT to send incoming data to Kinesis Firehose, and for the stream only a delivery destination in S3 need be configured.

Listing 6.1 shows a configuration of the AWS IoT action in CloudFormation. In this listing, Lines 6-8 construct the IoT-Sql string. The statement selects the complete content of every message sent to any topic starting with the event name followed by a forward slash. The whole message may then be forwarded unchanged to Kinesis Firehose.

Regarding Deployment, the Raw data pass-through lane may be implemented using only a CloudFormation template which creates and connects all required resources with no need for additional configuration code. The event name may be used to separate deployed instances of the platform and the data of events e.g. as shown in listing 6.1.

FIG. 6.1 shows a high-level view of a platform typically using Kinesis Firehose and/or AWS Lambda to implement the stateless stream processing and/or data pass-through lane and/or using AWS IoT for data ingestion and/or using S3 and DynamoDB in the persistence layer. Typically, the analytics in the Stateless stream processing lane are implemented entirely in Lambda functions. The AWS IoT rule engine may route incoming data to correct functions based on the topic the message was sent to. For JSON documents the content of data packets may be examined as well.

Regarding Deployment, the Stateless stream processing lane may be implemented in a CloudFormation stack. Before the stack is deployed the analytics package may be made available in an S3 location accessible to CloudFormation. CloudFormation may create a Lambda function from the supplied analytics package and connect the lambda function to an AWS IoT rule action that can invoke the function.

Regarding Auto scaling, since other than the DynamoDB table used to store analytics results all services are auto scaling, the only additional monitoring may be a Lambda function to monitor and adjust its capacity units. The implementation of the lambda function is described herein.

Regarding deployment of the Stateful stream processing lane, the complete infrastructure for the lane may as for other lanes be implemented as a CloudFormation stack. Besides resources used to process the data, CloudWatch alarms and Lambda functions may be deployed to monitor and adjust the capacity of the DynamoDB tables and Kinesis stream.

The analytics code package and/or Camel route configuration files may be uploaded to an S3 bucket before the stack is created. CloudFormation may supply the location and perhaps other parameters to new analytics instances in an initialization script which can download the code package and configuration files during initial bootstrapping.

FIG. 6.2 shows a high-level view of a stateful stream processing lane. Data arrives at AWS IoT from which the data is sent to a Kinesis stream. The data is assigned to a shard in the stream e.g. based on a chosen partition key such as the topic the data was sent to or may be constructed from the content of the received data. From there the data is picked up by one of the analytics worker instances and processed and the result stored in a DynamoDB table.

Analytics nodes may be created from a customized Amazon machine image (AMI.) which typically already contains all libraries required to start the framework for processing analytics. The instances may be created from a stock image and setup everything during bootstrapping but using a pre-configured image saves around 30 seconds which would otherwise be spent downloading and configuring software, which is a lot considering the total time to launch a new instance is typically under two minutes.

The configuration script only has to download the analytics package and insert the names of the Kinesis stream to poll and the DynamoDB tables to use for storing analytics results and states into variables defined in the configuration files. After the bootstrapping is complete the framework will be launched as a respawning daemon process to ensures it is restarted in the event of failure.

Analytics performed by instances of the Auto Scaling group can be configured using Apache Camel routes. Camel is a framework to facilitate exchange, processing and transformation of messages between components. The path a message takes in the system is called a route. FIG. 6.3 shows a Camel route that reads records from Kinesis and aggregates the records into analytics windows which are then sent to analytics processors. The results of the processors may be stored in DynamoDB. Route definitions may be supplied using, say, Camel's Java DSL, Spring XML or Java annotations. For this situation XML, for example, is suitable since xml allows complete reconfiguration of the analytics without recompiling any code. Camel routes are constructed from components hence all analytics are typically implemented as full-fledged Camel Components or at least implement Camel's Processor interface thereby allowing analytics to be plugged anywhere into a route. For convenience a partial implementation of the Processor interface has been provided as an abstract class.

The listing of FIG. 9 shows a part of a Spring XML file for a Camel route. It configures a segment of a Camel route implementing a sliding window on a stream of message using Camel's Splitter and Aggregator message processors. The segment uses a bean method to replicate the message to as many windows as may be necessary then aggregates the messages of each window again as shown in FIG. 6.3. Afterwards the now aggregated windows may be routed to their respective analytics processors.

The analytics store results and state e.g. in DynamoDB tables by default. This is an option not a requirement; these can be replaced with other Camel components by changing the component uri string in the route configuration file, assuming the specified resource exists and access permissions are provided. If that is not the case the CloudFormation stack may be updated with any necessary resources and policies. The Camel AWS module provides component implementations for various AWS services.

The Kinesis client component is implemented using the Kinesis Client Library (KCL.) implementing a custom Kinesis client component based on KCL instead of using the Camel component may be advantageous e.g. because the KCL can maintain a balanced assignment of shards to workers and may reassign shards when worker instances are created or terminated as a result of scaling.

The KCL also provides control over when to create checkpoints in the processed shard. In case of failure, a client on another worker typically must be able to resume processing of the shard from the last checkpoint. Since all data on the instance is ephemeral it is typically necessary to ensure that data can be re-read from the stream as long as it is still potentially needed.

The analytics processors are responsible for recovering any analytics state data necessary to resume processing data from the DynamoDB table. Services used to implement this lane are not auto-scaling services. To make them react to the platform's load additional monitoring capabilities may be added.

Analytics Nodes: The EC2 Auto Scaling service provides the ability to define scaling policies for groups of instances. These work in conjunction with CloudWatch monitoring. Whenever a metric exceeds or falls below a set threshold an alarm is triggered and the associated scaling policy is invoked. The defined scaling policies may be triggered on any subset of or both of the following conditions:
a) high CPU utilization e.g. If the average combined CPU utilization of the group's instances has exceeded a suitable threshold e.g. p % such as 80% during the last m e.g. five minutes a new instance will be added to the group.
b) low CPU utilization: If the average (or other central tendency) combined CPU utilization of the group's instances has stayed below p % e.g. 50% for n e.g. two consecutive periods of m e.g. 15 minutes. Depending on the analytics performed it may be desirable to create more alarms and monitor additional metrics, e.g. the memory consumption of the analytics instances. The current policies only launch or terminate single instances but launching/terminating more instances is more suitable for larger groups. When instances are launched or terminated the KCL typically takes care of reassigning the shards of the Kinesis stream. In case of instance launches it may be desirable to split shards to ensure there is at least one shard for each worker instance available to process.

A Lambda function may be implemented to adjust the capacity of the Kinesis stream as needed. It can be invoked in a scheduled intervals and but may also be invoked suitably e.g. every time one or any of the following conditions is met:
a) the total number of incoming records or bytes is less than p % e.g. 60% of the stream's capacity. Typically, the function examines the shard level metrics of the stream for the last two (say) alarm periods then attempts to join any two (say) neighboring shards if the resulting shard uses less then 75% (say) of its total capacity. Joining shards with higher used capacities has the potential to result in race conditions where shards are repeatedly split and merged again and again.
b) the read or write capacity of the stream was exceeded. Typically, the function examines the shard level metrics of the stream and splits any shards that exceeded their capacity at least once (say) during the last alarm period. Because the distribution of the keys across the shard's key space is unknown the split operation typically evenly distributes the key space among the child shards.
c) worker instances are created or terminated. Typically, these invocations result from scaling events of the analytics worker group. Whenever an instance is created the function typically ensures that there exists at least one shard for the new worker instance to process. Decisions whether the stream capacity can be reduced may be based on the Cloudwatch metrics of the stream.

Regarding the Batch processing lane, depending on how the lane is to be used one or two CloudFormation templates may be employed. Typically a single template is sufficient if the EMR cluster used for the analytics is managed by the Data Pipeline service in which case the cluster configuration is part of the pipeline definitions included in the template. If the cluster is to be created by CloudFormation using the EMR service at least two templates may be provided, the first one of which creates the EMR cluster, bootstraps that cluster with the TaskRunner application and assigns that cluster a unique WorkerGroup name so that cluster can receive jobs from the Data Pipeline service. All further templates contain the definitions of the pipelines to create. When these stacks are deployed the WorkerGroup name assigned to the EMR cluster in the first template is typically passed as a parameter so the jobs will be executed on this cluster.

FIG. 6.4 shows a high-level view of the implementation of the batch processing lane.

Regarding the batch processing lane, if a cluster is not managed by the Data Pipeline service the EMR-autoscaling solution by ImmobilienScout24 can be deployed with CloudFormation after the cluster has been created. In both cases it is also possible to define EMR Auto Scaling policies manually using the web interface after the stack has been deployed and the cluster has finished bootstrapping. The policies are part of the cluster configuration and do not interfere with CloudFormation when the stack is updated or removed. If an update requires the recreation of the cluster or the Data Pipeline service disposes of the cluster, policies may be recreated.

On demand pipeline executions: typically, CloudFormation cannot modify the configuration of existing resources. However event notifications are part of a bucket's configuration which may involve adding an event to invoke a Lambda function which triggers an on demand pipeline which may not be possible because the S3 bucket is created by the template of a different lane. A custom resource, the S3 BucketMonitor, may be created to work around this limitation. The monitor is a virtual resource created by Cloudformation. Listing 6.2. aka FIG. 7b shows an example configuration. The ServiceToken is the ARN (Amazon Resource Name, a unique identifier within AWS) of the Lambda function that creates, deletes and updates the monitor when the stack is created, deleted or updated. The LambdaFunctionArn is the ARN of the Lambda that may be invoked by the event and which activates the on demand pipeline. The PipelineId parameter is a unique identifier for the pipeline. PipelineId may be used as an identifier for the notification added to the bucket. Thus the notification may be deleted and updated when the stack configuration changes. The Bucket and Prefix parameters define for which bucket and object key prefix an event notification should be created.

Referring again to FIG. 6.4, on delivery of a batch of raw data from Kinesis Firehose to S3 an event is typically triggered. Because there is no direct integration of S3 with the Data Pipeline service a Lambda function may be executed. The function then typically activates the pipeline associated with the delivery location and supplies the bucket and/or key of the new object as parameters. If the intervals between pipeline activations are longer than, say, 15 minutes the scheduler of the Data Pipeline service can be used. For activations in shorter intervals the Lambda scheduler provides the ability to trigger, say, every minute.

One method to scale an EMR cluster is auto-scaling using e.g. Amazons EMR Auto Scaling. Another option is the Data Pipeline approach which may not be considered true auto scaling but the Data Pipeline service can ensure the resource requirements specified in the task definitions will be met by adding task instances as appropriate. This is a suitable method for clusters managed by the Data Pipeline service because unlike scaling policies for EMR clusters these definitions can be deployed together with everything else using CloudFormation.

Regarding Workflow management, Workflows may be embodied differently in each of the processing lanes. An option that is available in all lanes is to write data back to the ingestion layer. From there the data can be routed to a different analytics workflow in the same or a different lane. Workflows in the stateless stream processing lane may be expressed in the code of the Lambda function invoked by AWS IoT. The function's code may encompass the complete workflow or may in turn invoke other Lambda functions or services. In the stateful stream processing lane the workflows may be defined through the Camel routes connecting the different analytic operations. The Data Pipeline service typically supports the definition of workflows in the batch processing lane e.g. with a visual designer. As an alternative Apache Oozie worflows may be designed in XML. Oozie is available for Amazon EMR as part of the Hadoop user experience (Hue) application package.

Regarding Data ingestion, AWS IoT may be used to implement the ingestion layer of the platform e.g. because it can fit the characteristics of the analyzed use cases. A scenario where many data producers send data at varying rates and of relatively small size. If these assumptions change other options can be considered and used. In a scenario with only a few data producers sending data at high volumes Amazon Kinesis may be used as a service in the ingestion layer since Kinesis can ingest data at a high rate per client, relative, say, to AWS IoT. S3 can be an alternative e.g. in a scenario where many clients send huge blobs of data, e.g. a situation where users can submit photos or videos from their phones for analysis. A third scenario is synchronous requests where the analytic result is not sent to a data store in the persistence layer and rather is sent back directly to the client. In these cases the API Gateway can be an alternative. Using one of these options and AWS IoT is not mutually exclusive; both can be used in a complementary fashion. Other services may lack AWS IoT's authentication and authorization scheme.

Regarding Data storage and delivery, S3 and/or DynamoDB may be chosen as data storage and delivery database services e.g. because they can fit presented use cases and are well integrated with other services. It is appreciated that alternatively, an ElastiCache Redis may be used for fast serving of analytics results, a Redshift data warehouse or RDS relational database may be used to enable SQL compatible analytics tools and an Elasticsearch cluster may be used to provide fast full text searches.

The architecture of the platform may include four lanes to fit requirements of current analytics use cases and to enable support of other types of use cases by adding new lanes. For example, if a lane that supports real-time stateful stream analytics is needed using AWS, then Lamba and DynamoDB can be a solution alongside the illustrated 4 lanes. Also, lanes that are not needed can be omitted from a deployment, also, lanes can be deployed multiple times.

AWS provides an ability to invoke Lambda functions to process data ingested by Kinesis Firehose; this allows the raw data pass-through lane and stateless stream processing lane to be collapsed into a single lane using Kinesis Firehose and Lambda to implement a micro-batching lane. This may under certain circumstances hamper the real-time capabilities provided by the stateless stream processing lane.

According to certain embodiments, the batch processing lane may be replaced with a lane implementation using AWS Batch in view of its auto-scaling capability.

According to certain embodiments, logic is added in the stateful stream processing lane to coordinate distribution of work and/or recover from failures.

Inter alia, certain embodiments seek to provide an IoT analytics platform to analyze IoT data gathered at music, sports and other events characterized by changing conditions during events and different kinds and iterations of events, as a result of which it is desirable for the platform to be highly flexible and/or scalable and/or adaptable, not only in terms of the amounts of data the platform may need to process but also in terms of various different types of analytics it may need to support as well e.g. the statistics collected during a basketball game are not the same as those collected during a football game and both of these differ greatly from the IoT analytics which may be performed during a musical event. This need to be highly flexible and/or scalable and/or adaptable may be facilitated by providing managed services and serverless technologies which require little setup and provide auto scalability.

Analysis of a suitable “sample” of common analytics use cases may be used to yield a classification system that categorizes families of analytics use cases into one of various analytics classes. Mapping the distribution of use cases across the classes it may be discovered that a platform capable of supporting the requirements of only a subset (say: only four) of the classes is able to support all or almost all common analytics use cases. Then, a platform may be designed as a three (say) layered architecture in which a central processing layer includes L e.g. three lanes that each support different types of analytics classes. An additional lane may be added to gather data without processing that data. The lanes are typically self-contained so they can each be deployed zero, once, or plural multiple times with minimal dependencies on one another.

It may be desired to provision servers to conduct some of the analytics and to support all of the analytics classes. Using the CloudFormation service it is possible to conveniently, consistently and reproducibly deploy the platform including providing customization and configuration options to tailor each deployment to needs of a specific event.

It is sometimes impossible to achieve auto scalability in a platform by selecting only services that provide auto scalability e.g. because for some tasks contemplated for the platform, there is no service that provides auto scalability. However monitoring components/solutions e.g. as described herein may be provided and integrated into the platform thereby to provide auto scalability for the platform as a whole. Of course, at least some services that do not inherently support auto scaling may be replaced, retroactively, with others that do.

A selection of use cases for which a platform may be employed, may include any subset or all of the following:
Mood detection
Style detection
User profiling
Content generation
Trend analysis
Anomaly detection
Predictive maintenance
Activity recognition

Referring again to FIG. 3c, the stateful stream processing and batch lanes may according to certain embodiments be implemented as follows:

CloudFormation may create and configure some or all of the following resources:
S3 bucket to store the incoming raw data
Kinesis Firehose delivery stream
AWS IoT rule with an action to forward incoming raw data to the delivery stream

Additional IAM roles and policies created to manage permissions for services have been omitted for brevity. No additional monitoring is needed because all used services are fully auto scaling.

In total, CloudFormation may be used create and configure some or all of the following resources:
Lambda functions to monitor analytics result and state DynamoDB tables
Lambda function to adjust Kinesis shard count
DynamoDB tables to persist analytics results and state
EC2 Auto Scaling group of analytics worker instances
Kinesis stream to buffer and partition incoming raw data
Custom resource to enable shard level metrics for the Kinesis stream
AWS IoT rule with an action to forward incoming raw data to Kinesis stream
Cloudwatch alarms to monitor the auto scaling group of analytics instances and the Kinesis stream

### DynamoDB Tables:

The DynamoDB tables may be actively monitored by a Lambda function which may not utilize Cloudwatch alarms but is instead invoked in regular time intervals. The function typically examines the Cloudwatch metrics of the tables collected during the last 30 minutes to determine if the capacity units should be increased or decreased.

Scaling Kinesis streams inside the stateful stream processing lane is typically more flexible, compared to the scaling done by the UpdateShardCount function of the Kinesis Streams API: The Kinesis Streams API function may maintain an equal distribution of the key space across the shards of a stream and may be limited to, say, two invocations per UTC day whereas the method shown and descried herein adapts the distribution to the actual data over time and/or can be invoked at will without limitation. If the uneven distribution of the stream's capacity has had adverse effects on its performance in the long run, the UpdateShardCount function, for example, may be used to restore equal distribution. However, typically, the expected lifetime (most commonly days or weeks) of platform instances are short enough such that such restoration is not necessary.

Referring again to FIG. 3c, it is appreciated that the following lanes illustrated therein, need not all be provided in all embodiments:
1: raw data pass through
2: stateless stream processing
3: statefull stream processing
4: batch processing
   Embodiments include but are not limited to:
O) Having all lanes as illustrated.
A) omitting lane 1: e.g. if raw data need not to be preserved, e.g. for cost or privacy reasons, and/or if no batch processing (lane 4) on raw data is required. Typically, the input data for lane 4 can only be the results generated by lanes 2 and 3 and possibly previous runs of lane 4.
B) omitting lanes 1 and 4: This is particularly suitable given the conditions above in (A), and if no batch processing of results from lanes 2, 3 is needed such that lane 4 is not needed.
C) omitting lane 4: This is particularly suitable if no batch processing is needed at all, but raw data is to be preserved. This also is particularly suitable, if batch processing can be simulated (replaced) by stream processing, e.g. in cases in which batches are read linearly anyway, e.g. the data is being read sequentially without randomly hopping around in the set of data points—in which case an entire lane can be conserved without losing functionality.
D) omitting lanes 2 and/or 3: Stream processing can be simulated (repLaced) by batch processing if time constraints so allow e.g. if no real-time (<1 sec) scenarios are present and near real time (>1 sec) is sufficient. In this case, incoming data streams may be packaged into micro batches and processed micro-batch by micro-batch. This is particularly suitable if stateless and stateful batch processing lanes are provided e.g. as per embodiment X below, as all scaling properties (bigger machines vs. more machines) can then be preserved by replacing stateless stream with stateless batch and stateful stream with stateful batch.
X) replacing lane 4 with two lanes: stateful batch processing (lane 5) and stateless batch processing (lane 6). Any definitions and properties and uses and other particulars of stateful/stateless described herein for stream processing lanes may apply similarly to the stateful/stateless batch embodiment. This embodiment is particularly useful e.g. when it is desired to make use of different scaling properties of stateless (more vs. less machines) and statefull (bigger vs. smaller machines) processing in the batching layers, and/or as a suitable implementation of embodiment (D) above.

According to certain embodiments, only the lanes specifically stipulated herein in that embodiment are provided, and no other lanes.

Teachings which may be suitably combined with any of the above embodiments, are now described.

According to certain embodiments, an auto scalable analytics platform is implemented for a selected number of common IoT analytics use cases in the AWS cloud by following a serverless first approach.

First, a number of prevalent analytics use cases are examined with regard to their typical requirements. Based on common requirements, categories are established and a platform architecture with lanes tailored to the requirements of the categories is designed. Following this step, services and technologies are evaluated to assess their suitability for implementing the platform in an auto scalable fashion. Based on the insights of the evaluation, the platform can then be implemented using, automatically, scaling services managed by the cloud provider where it is feasible.

Implementing an auto scalable analytics platform can be achieved with ease for analytics use cases that do not require state by selecting auto scaling services as its components. In order to support analytics uses cases that require state, provisioning of servers can be performed.

Analytics platforms can be used to gather and process Internet of Things (IoT) data during various public events like music concerts, sports events or fashion shows. During these events, a constant stream of data is gathered from a fixed number of sensors deployed on the event's premises. In addition, a greatly varying amount of data is gathered from sensors the attendees bring to the event. Data is collected by apps installed on the mobile phones of the attendees, smart wrist bands and other smart devices worn by people at the event. The collected data is then sent to the cloud for analytics. As these smart devices become even more common, the volume of data gathered from these can vastly outgrow the volume of data collected from fixed sensors.

Besides the described fluctuations in the amount of data gathered during a single event, there are also significant differences between the load generated by different events, and different types of events.

Experience with past events has shown that some of the components of the current analytics platforms have limitations regarding their ability to scale automatically. One solution has been to over-provision capacity. The new platform is typically able to adapt to changing conditions over the course of an event as well as conditions outside events and at different events automatically. This is becoming even more important as plans for future ventures call for the ability to scale the platform well beyond hundreds of thousands into the range of millions of connected devices.

Certain embodiments seek to provide auto scalability when scaling up as well as when scaling down e.g. using self-scaling services managed by the cloud provider to help avoid over provisioning, while at the same time supporting automatic scaling. Infrastructure configuration, as well as scaling behavior, can be expressed as code where possible to simplify setup procedures and preferably consolidate infrastructure as well.

The platform as a whole currently supports data gathering as well as analytics and results serving. The platform can be deployed in the Amazon AWS cloud (https://aws.amazon.com/).

The existing analytics platform is based on a variety of home-grown services which are deployed on virtual machines. Scalability is mostly achieved by spinning up clones of the system on more machines using EC2 auto scaling groups. Besides EC2 , the platform already uses a few other basic AWS services such as S3 and Kinesis.

Presented here are a number of use cases that are representative of past usages of the existing analytics platform. The type of analytics performed to implement the use cases are then analyzed to find commonalities and differences in their requirements to take these into consideration.

### 3.1 Analytics Use Case Descriptions

The platform can be able to meet the requirements of the following selection of common uses cases from past projects and be open to new ones.

### 3.1.1 Data Transformation

Transformations include converting data values or changing the format. An example of a format conversion is rewriting an array of measurement values as individual items for storage in a data base. Another type of conversion that might be applied is to convert the unit of measurement values, i.e. from inches to centimeters, or from Celsius to Fahrenheit.

### 3.1.2 Meta Data Enrichment

Sensors usually only transmit whatever data they gather to the platform. However, data on the deployment of the sensor sending the data, might also be relevant to analytics. This applies even more to mobile sensors which mostly do not remain stay at the same location over the course of the complete event. In case of wrist bands they might also not be worn by the same person all the time. Meta data on where and when data was gathered, may therefore be valuable. Especially when dealing with wearables it is useful to know the context in which the data was gathered. This includes the event at which the data was gathered, but also the role of the user from whom the data was gathered, e.g. a referee or player at a sports event, a performer at a concert, or an audience member.

In order to perform meaningful analytics, metadata can either be added directly to the collected data, or by reference.

### 3.1.3 Filtering

An example of filtering is checking if a value exceeds a certain threshold or conforms to a certain format. Simple checks only validate syntactic correctness. More evolved variants might try to determine if the data is plausible by checking it against a previously established model, attempting to validate semantic correctness. Usually any data failing the check can be filtered out. This does not necessarily mean the data is discarded; instead the data may require special additional treatment before it can be processed further.

### 3.1.4 Simple Analytics

When performing anomaly detection, the data is compared against a model that represents the normal data. If the data deviates from the model's definition of normal, it is considered an anomaly.

This differs from the previously described filtering use case because in this case the data is actually valid. However, anomalies typically still warrant special treatment because they can be an early indicator that there is or that there might be a problem with the machine, person or whatever is monitored by the sensor.

### 3.1.5 Preliminary Results and Previews

Sometimes it is desired to supply preliminary results or previews e.g. by performing a less accurate but computationally cheaper analytics on all data or by processing only a subset of the available data before a more complete analytics result can be provided later.

Generally the manner in which a meaningful subset of the data can be obtained depends on the analytics. One possible method is to process data at a lower frequency than it is sampled by a sensor. Another method is to use only the data from some of the sensors as a stand-in for the whole setup. Based on these preliminary results, commentators or spectators of live events can be supplied with approximate results immediately.

Preliminary analytics can also determine that the quality of the data is too low to gain any valuable insights, and running the full set of analytics might not be worthwhile.

### 3.1.6 Advanced Analytics

Here presented are analytics designed to detect more advanced concepts. Examples may include analytics that are able not only to determine that people are moving their hands or their bodies, but that are instead able to detect that people are actually applauding or dancing.

For example, current activity recognition solution performs analytics of video and audio signals on premises. These lower level results are then sent to the cloud. There, the audio and video analytics results for a fixed amount of time are collected. The collected results sent by the on-premises installation and the result of the previous activity recognition run performed in the cloud, are part of the input for the next activity recognition run.

### 3.1.7 Experimental Analytics

This encompasses any kind of analytics that might be performed by researchers whenever new things are tested. Usually these analytics are run against historical raw data to compare the results of a new analytic or a new version of an analytic against the results of its predecessors.

### 3.1.8 Cross-Event Analytics

This use case subsumes all analytics performed using the data of multiple events. Typical applications include trend analytics to detect shifts in behavior or tastes between events of the same type or between event days. For example, most festival visitors loved the rap performances last year, but this year more people like heavy metal.

This also includes cross-correlation analytics to find correlations between the data gathered at two events, for example people that attend Formula One races might also like to buy the clothes presented at fashion shows.

Another important application is insight transfer, where, for example, the insights gained from performing analytics on the data of basketball games are applied to data gathered at football matches.

### 3.2 Analytics Dimensions

Even from short descriptions of given analytics use cases it may become apparent that there are differences between use-cases e.g. in the granularity of data required, the need to keep additional state data between computations and timing constraints extending from a need for real-time capabilities on the one hand, to batch processing historic data on the other hand.

### 3.3 Infrastructure Deployment

Usually an event is only a few days long. This means running the platform continuously may be inefficient.

Auto scaling can minimize the amount of deployed infrastructure. The reasons for this are that scaling has limits. While some services can scale to zero capacity, for others there is a lower bound greater than zero. Examples of such services in the AWS cloud are Amazon Kinesis and DynamoDB. In order to create a Kinesis stream or a DynamoDB table, a minimum capacity has to be allocated.

The platform can be created relatively shortly before the event and destroyed afterwards. Setting it up is preferably fully automated and may be completed in a matter of minutes.

Furthermore, it can be possible to deploy multiple instances of the platform concurrently e.g. one per region or one for each event, and dispose of them afterwards.

The Infrastructure as Code approach facilitates these objectives by promoting the use of definition files that can be committed to version control systems. As described in [74] this results in systems that are easily reproduced, disposable and consistent.

By using Infrastructure as Code there is no need to keep superfluous infrastructure because it can always be easily recreated. This also ensures that if a resource is destroyed, all associated resources are destroyed as well, except what has been designated to be kept e.g. data stores.

### Architectural Design

Here presented is the architectural design of the platform, which can be developed based on the findings of the use case analysis.

### 5.1 Service and Technology Descriptions

AWS services which may be used are now described, including various services' features, and their ability to automatically scale up and down, as well their limitations.

### 5.1.1 AWS IoT

AWS IoT provides a service for smart things and IoT applications to communicate securely via virtual topics using a publish and subscribe pattern. It also incorporates a rules engine that provides integration with other AWS services.

To take advantage of AWS IoT's features, a message can be represented in JSON. This (as well as other requirements herein) is not a strict requirement; the service can work substantially with any data, and the rules engine can evaluate the content of JSON messages.

FIG. 6a, aka FIG. 5.1 shows a high-level view of the AWS IoT service and how devices, applications and other AWS services can use it to interact with each other. The following list gives short summaries for each of its key features. [43, 62]
Message broker The message broker enables secure communication via virtual topics that devices or applications can publish or subscribe to, using the MQTT protocol. The service also provides a REST interface that supports the publishing of messages.
Rules engine An SQL-like language allows the definition of rules which are evaluated against the content of messages. The language allows the selection of message parts as well as some message transformations, provided the message is represented in JSON. Other AWS services can be integrated with AWS IoT by associating actions with a rule. Whenever a rule matches, the actions are executed and the selected message parts are sent to the service. Notable services include DynamoDB, CloudWatch, ElasticSearch, Kinesis, Kinesis Firehose, S3 and Lambda. [44]
The rules engine can also leverage predictions from models in Amazon ML, a machine learning service. The machinelearning_predict function is provided for this by the IoT-SQL dialect. [45]
Security and identity service All communication can be TLS encrypted. Authentication of devices is possible using X.509 certificates, AWS IAM or Amazon Cognito. Authorization is done by attaching policies to the certificate associated with a device. [46]
Thing registry The Thing registry allows the management of devices and the certificates associated therewith. It also allows to store up to three custom attributes for each registered device.
Thing shadow service Thing shadow service provides a persistent representation of a device in the cloud. Devices and applications can use the shadow to exchange information about the state of the device. Applications can publish the desired state to the shadow of a device. The device can synchronize its state the next time it connects.

### Message Delivery

AWS IoT supports quality of service levels 0 (at most once) and 1 (at least once) as described in the MQTT standard [56] when sending or subscribing to topics for MQTT and REST requests. It does not support level 2 (exactly once) which means that duplicate messages can occur [47].

In case an action is triggered by a rule but the destination is unavailable, AWS IoT can wait for up to 24 hours for it to become available again. This can happen if the destination S3 bucket was deleted, for example.

The official documentation [44] states that failed actions are not retried. That is however not the observed behavior, and statements by AWS officials suggest that individual limits for each service exist [55]. For example AWS IoT can try to deliver a message to Lambda up to three times and up to five times to DynamoDB.

### Scalability

AWS IoT is a scalable, robust and convenient-to-use service to connect a very large number of devices to the cloud. It is capable of sustaining bursts of several thousand simulated devices, publishing data on the same topic without any failures.

### Service Limits

Table 5.1 aka FIG. 4a covers limits that apply to AWS IoT. All limits are typically hard limits hence cannot be increased. AWS IoT's limits are described in [60].

### 5.1.2 AWS CloudFormation

CloudFormation is a service that allows to describe and deploy infrastructure to the AWS cloud. It uses a declarative template language to define collections of resources. These collections are called stacks [35]. Stacks can be created, updated and deleted via the AWS web interface, the AWS cli or a number of third party applications like troposphere and cfn-sphere (https://github.com/cloudtools/troposphere and https://github.com/cfn-sphere/cfn-sphere).

### AWS Resources and Custom Resources

CloudFormation only supports a subset of the services offered by AWS. The full list of currently supported resource types and features can be found in [36]. A CloudFormation stack is a resource too and can as such be created by another stack. This is referred to as nesting stacks [37].

It is also possible to extend CloudFormation with custom resources. This can be done by implementing an AWS Lambda function that provides the create, delete and update functionality for the resource. More information on custom resources and how to implement them can be found in [38].

### Deleting a Stack

When a stack is deleted, the default behavior is to remove all resources associated with it. For resources containing data like RDS instances and DynamoDB tables, this means the data held might be lost. One solution to this problem is to back up the data to a different location before the stack is deleted. But this moves the responsibility outside of CloudFormation and oversights can occur. Another solution is to override this default behavior by explicitly specifying a DeletionPolicy with a value of Retain. Alternatively, the policy Snapshot can be used for resources that support the creation of snapshots. CloudFormation may then either keep the resource, or create a snapshot before deletion.

S3 buckets are an exception to this rule because it is not possible to delete a bucket that still contains objects. While this means that data inside a bucket is implicitly retained when a stack is deleted, it also means that CloudFormation can run into an error when it tries to remove the bucket. The service can still try to delete any other resources, but the stack can be left in an inconsistent state. It is therefore good practice to explicitly set the DeletionPolicy to Retain as shown in the sample template provided in FIG. 5a aka listing 5.1. [39]

### Service Limits

Table 5.2 aka FIG. 4b (AWS CloudFormation service limits) covers limits that apply to the CloudFormation service itself and stacks. Limits that apply directly to templates and stacks cannot be increased. However, they can be somewhat circumvented by using nested stacks. The nested stack is counted as a single resource and can itself include other stacks again.

### 5.1.3 Amazon Simple Workflow (SWF)

Amazon Simple Workflow (SWF) is a workflow management service available in the AWS cloud. The service maintains the execution state of workflows, tracks workflow versions and keeps a history of past workflow executions.

The service distinguishes two different types of tasks that make up a workflow:
Decision tasks implement the workflow logic. There is a single decision task per workflow. It makes decisions about which activity task can be scheduled next for execution based on the execution history of a workflow instance.
Activity tasks implement the steps that make up a workflow.

Before a workflow can be executed it can be assigned to a domain which is a namespace for workflows. Multiple workflows can share the same domain. In addition, all activities making up a workflow can be assigned a version number and registered with the service.

FIG. 6b aka FIG. 5.2 is a simplified flow diagram showing an exemplary flow of control during execution of a workflow instance. Once a workflow has been started, the service schedules the first decision task on a queue. Decider workers poll this queue and return a decision. A decision can be to abort the workflow execution, to reschedule the decision after a timer runs out, or to schedule an activity task. If an activity task can be scheduled, it is put in one of the activity task queues. From there it is picked up by a worker, which executes the task and informs the service of the result, which, in turn, schedules a new decision task and the circle continues until a decider returns the decision that the workflow either should be aborted or has been completed [24].

Amazon SWF assumes nothing about the workers executing tasks. They can be located on servers in the cloud or on premises. There can be very few workers running on large machines, or hundreds of small ones. SWF typically needs to be able to poll the service for tasks.

This makes it convenient to scale the amount of workers on demand. SWF also allows to implement activity tasks (but not decision tasks) using AWS Lambda which makes scaling even easier [25].

AWS supplies SDKs for Java, Python, .NET, Node.js, PHP and Ruby to develop workflows as well as the Flow Frameworks for Java and Ruby which use a higher abstraction level when developing workflows and even handle registration of workflows and domains through the service. As a low level alternative, the HTTP API of the service can also be used directly [26].

### Service Limits

The table of FIG. 4c (Amazon Simple Workflow service limits) describes default limits of the Simple Workflow service and whether they can be increased. A complete list of limits and how to request an increase can be found in [27].

### 5.1.4 AWS Data Pipeline

AWS Data Pipeline is a service to automate moving and transformation of data. It allows the definition of data-driven workflows called pipelines. Pipelines typically comprise a sequence of activities which are associated with processing resources. The service offers a number of common activities, for example to copy data from S3 and run Hadoop, Hive or Pig jobs. Pipelines and activities can be parameterized but no new activity types can be added. Available activity types and pipeline solutions are described in [40].

Pipelines can be executed on a fixed schedule or on demand. AWS Lambda functions can act as an intermediary to trigger pipelines in response to events.

The service can take care of the creation and destruction of all compute resources like EC2 instances and EMR clusters necessary to execute a pipeline. It is also possible to use existing resources in the cloud or on a premises. For this the TaskRunner program can be installed on the resources and the activity can be assigned a worker group configured on one of those resources. [41]

The Pipeline Architect illustrated in FIG. 5.3. aka FIG. FIG. 6c is a visual designer and part of the service offering. It can be used to define workflows without the need to write any code or configuration files.

The designer allows the export of pipeline definitions in a JSON format. Experience shows that it is easiest to build the pipeline using the architect, then export it using the AWS Python SDK. The resulting JSON may then be adjusted to be usable in CloudFormation templates.

### Service Limits

The table of FIG. 4d (AWS Data Pipeline service limits) gives an overview of default limits of the Data Pipeline service and whether they can be increased. The complete overview of limits and how to request an increase is available at [42]. These are only the limits directly imposed by the Data Pipeline service. Account limits like the number of EC2 instances that can be created, can impact the service too, especially when, for example, large EMR clusters are created on demand. Re footnote 1, this is a lower limit which typically can't be decreased any further.

### 5.1.5 Amazon Kinesis Firehose

Kinesis Firehose is a fully managed service with the singular purpose of delivering streaming data. It can either store it in S3 , or load it into a Redshift data warehouse cluster, or an Elasticsearch Service cluster.

### Delivery Mechanisms

Kinesis Firehose delivers data to destinations in batches. The details depend on the delivery destination. The following list summarizes some of the most relevant aspects for each destination. [14]
Amazon S3 The size of a batch can be given as a time interval from 1 to 15 minutes and an amount of 1 to 128 megabytes. Once either the time has passed, or the amount has been reached, Kinesis Firehose can trigger the transfer to the specified bucket. The data can be put in a folder structure which may include the date and hour the data was delivered to the destination and an optional prefix. Additionally, Kinesis Firehose can compress the data with ZIP, GZIP or Snappy algorithms and encrypt the data with a key stored in Amazon's key management service KMS e.g. as shown in FIG. 5.4 aka FIG. 6d.

Kinesis Firehose can buffer data for up to 24 hours if the S3 bucket becomes unavailable or if it falls behind on data delivery.
Amazon Redshift Kinesis Firehose delivers data to a Redshift cluster by sending it to S3 first. Once a batch of data has been delivered, a COPY command is issued to the Redshift cluster and it can begin loading the data. A table with columns fitting the mapping supplied to the command can already exist. After the command completes, the data is left in the bucket.

Kinesis Firehose can retry delivery for up to approximately 7200 seconds then move the data to a special error folder in the intermediary S3 bucket.
Amazon Elasticsearch Service Data to an Elasticsearch Service domain is delivered without a detour over S3 . Kinesis Firehose can buffer up to approximately 15 minutes or approximately 100 MB of data then send it to the Elasticsearch Service domain using a bulk load request.

As with Redshift, Kinesis Firehose can retry delivery for up to approximately 7200 seconds then deliver the data to a special error folder in a designated S3 bucket.

### Scalability

The Kinesis Firehose service is fully managed. It scales automatically up to the account limits defined for the service.

### Service Limits

Table 4e (Amazon Kinesis Firehose service limits) describes default limits of the Kinesis Firehose service and whether they can be increased. The limits on transactions, records and MB can only be increased together. Increasing one also increases the other two proportionally. All limits apply per stream. A complete list of limits and how to request an increase can be found in [15].

### 5.1.6 AWS Lambda

The AWS Lambda service provides a computing environment, called a container, to execute code without the need to provision or manage servers. A collection of code that can be executed by Lambda is called a function. When a Lambda function is invoked, the service provides its code in a container, and calls a configured handler function with the received event parameter. Once the execution is finished, the container is frozen and cached for some time so it can be reused during subsequent invocations.

Generally speaking, this means Lambda functions do not retain state across invocations. If the result of a previous invocation is to be accessed, an external database can be used. However, in case that the container is unfrozen and reused, previously downloaded files can still be there. The same is true for statically initialized objects in Java or variables defined outside the handler function scope in Python. It is advisable to take advantage of this behavior because the execution time of Lambda functions is billed in 100 millisecond increments [48].

All function code is written in one of the supported languages. Currently Lambda supports functions written in Node.js, Java, Python and C#.

Possibly the biggest limitation of Lambda is the maximum execution time of 300 seconds. If a function does not complete inside this limit, the container is automatically killed by the service. Functions can retrieve information about the remaining execution time by accessing a context object provided by the container.

To cut down execution time, the Lambda function size can be increased by allocating more memory. Memory can be assigned to functions in increments of 64 MB starting at 128 MB and ending at 1536 MB. Allocating more memory automatically increases the processing power used to execute the function and the service fee by roughly the same ratio.

### Invocation Models

When a Lambda function is connected to another service it can be invoked in asynchronous or synchronous fashion. In the asynchronous case, the function is invoked by the service that generated the event. This is for example what happens when a file is uploaded to S3 . A CloudWatch alarm is triggered or a message is received by AWS IoT. In the synchronous case, also called stream-based, there is no event. Instead, the Lambda service can poll the other service at regular intervals and invoke the function when new data is available. This model is used with Kinesis when new records are added to the stream or DynamoDB when an item is inserted. The Lambda service can also invoke a function on a fixed schedule given as a time interval or a Cron expression [49].

### Scalability

The Lambda service is fully managed and can scale automatically without any configuration from very few requests per day, to thousands of requests per second.

### Service Limits

Table 4f (AWS Lambda service limits) describes default limits of the AWS Lambda service and whether they can be increased. A complete list of limits is described in [50].

Regarding the number of concurrent executions given for Lambda functions, while Lambda can potentially execute this many functions per second, other limiting factors can be considered.

For streaming sources like Kinesis, the Lambda service typically does not run more concurrent functions than the number of shards in the stream. In this case, the stream limits Lambda because the content of a shard is typically read sequentially, therefore no more than one function can process the contents of a shard at a time.

Furthermore, regarding the definition for the number of concurrent function invocations, a single function invocation can count as more than a single concurrent invocation. For event sources that invoke functions asynchronously, the value of concurrent Lambda executions may be computed from the following formula:

concurrent invocations=events per second*average function duration

A function that is invoked 10 times per second and takes three seconds to complete therefore counts not as 10 but 30 concurrent Lambda invocations against the account limit [51].

### 5.1.7 Amazon Kinesis Streams

Kinesis Streams is a service capable of collecting large amounts of streaming data in real time. A stream stores an ordered sequences of records. Each record is composed of a sequence number, a partition key and a data blob.

FIG. 6e shows a high-level view of a Kinesis stream. A stream typically includes shards with a fixed capacity for read and write operations per second. Records written to the stream are distributed across its shards based on their partition key. To make use of a stream's capacity, the partition key can be chosen in a way to provide equal distribution of records across all shards of a stream.

The Amazon Kinesis Client Library (KCL) provides a convenient way to consume data from a Kinesis stream in a distributed application. It coordinates the assignment of shards to consumers and ensures redistribution of shards when new consumers join or leave and shards are removed or added. Kinesis streams and KCL are known in the art and described e.g. in [18].

### Scalability

Kinesis streams do not scale automatically. Instead, a fixed amount of capacity is typically allocated to the stream. If a stream is overwhelmed, it can reject requests to add more records and the resulting errors can be handled by the data producers accordingly.

In order to increase the capacity of a stream, one or more shards in the stream have to be split. This redistributes the partition key space assigned to the shard to the two resulting child shards. Selecting which shard to split proceeds as per knowledge of the distribution of partition keys across shards. A method for how to re-shard a stream and how to choose which shards to split or merge is known in the art and described e.g. in [19].

AWS added a new operation named UpdateShardCount to the Kinesis Streams API. It allows to adjust a stream's capacity simply by specifying the new number of shards of a stream. However, the operation can only be used twice inside of a 24 hour interval and it is ideally used either for doubling or halving the capacity of a stream. In other scenarios it can create many temporary shards during the adjustment process to achieve equal distribution of the partition key space (and the stream's capacity) again [16].

### Service Limits

Table 4g (Amazon Kinesis Streams service limits) describes default limits of the Kinesis Streams service and whether they can be increased. The complete list of limits and how to request an increase can be found in [20]. Re footnote 1, typically Retention can be increased up to a maximum of 168 hours. Footnote 2: Whichever comes first.

### 5.1.8 Amazon Elastic Map-Reduce (EMR)

The Amazon EMR service provides the ability to analyze vast amounts of data with the help of managed Hadoop and Spark clusters.

AWS provides a complete package of applications for use with EMR which can be installed and configured when the cluster is provisioned. EMR clusters can access data stored in S3 transparently using the EMR File System EMRFS which is Amazon's implementation of the Hadoop Distributed File System (HDFS) and can be used alongside native HDFS. [11]

EMR uses YARN (Yet Another Resource Negotiator) to manage the allocation of cluster resources to installed data processing frameworks like Spark and Hadoop MapReduce. Applications that can be installed automatically include Flink, HBase, Hive, Hue, Mahout, Oozie, Pig, Presto and others [10].

### Scalability

There are various known solutions to scale an EMR cluster with each solution having its advantages.

EMR Auto Scaling Policies were added by AWS in November 2016. These have the ability to scale not only the instances of task instance groups, but can also safely adjust the number of instances in the core Hadoop instance group which holds the HDFS of the cluster.

Defining scaling policies is currently not supported by CloudFormation. One way to currently add a scaling policy is manually via the web interface [12].

emr-autoscaling is an open source solution developed by ImmobilienScout24 that extends Amzon EMR clusters with auto scaling behavior (https://www.immobilienscout24.de/). Its source code was published on their public GitHub repository in May 2016 (https://github.com/ImmobilienScout24/emr-autoscaling).

The solution is comprised of a CloudFormation template and a Lambda function written in Python. The function is triggered in regular intervals by a CloudWatch timer. It adjusts the number of instances in the task instance groups of a cluster. Task instance groups using spot instances are eligible for scaling [66].

Data Pipeline provides a similar method of scaling. It is typically only available if the Data Pipeline service is used to manage the EMR cluster. It is then possible to specify the number of task instances that can be added before an activity is executed when the pipeline is defined. The service can then add task instances using the spot market and remove them again once the task has completed.

One solution is to specify the number of task instances that can be available in the pipeline definition of an activity. Another solution can be if EMR scaling policies are added to CloudFormation. A solution by ImmobilienScout24 is one that can be deployed with CloudFormation.

### Service Limits

No limits are imposed on the EMR service directly. However, it can be impacted by the limits of other services. The most relevant one is the limit for active EC2 instances in an account. Because the default limit is set somewhat low at 20 instances, it can be exhausted fast when creating clusters.

### 5.1.9 Amazon Athena

AWS introduced a new service named Amazon Athena. It provides the ability to execute interactive SQL queries on data stored in S3 in a serverless fashion [5].

Athena uses Apache Hive data definition statements to define tables on objects stored in S3 . When the table is queried, the schema is projected on the data. The defined tables can also be accessed using JDBC. This enables the usage of business intelligence tools and analytics suites like Tableau (https://www.tableau.com).

Analytics use cases that require an EMR cluster can be evaluated and implemented with it.

### 5.1.10 AWS Batch

AWS Batch is a new service announced in December 2016 at AWS re:Invent and is currently only available in closed preview (https://reinvent.awsevents.com/). It provides the ability to define workflows in open source formats and executes them using Amazon Elastic Container Service (ECS) and Docker containers. The service automatically scales the amount of provisioned resources depending on job size and can use the spot market to purchase compute capacity at cheaper rates.

### 5.1.11 Amazon Simple Storage Service (S3 )

Amazon S3 provides scalable, cheap storage for vast amounts of data. Data objects are organized in buckets, which may be regarded as a globally unique name space for keys. The data inside a bucket can be organized in a file system such as abstraction with the help of prefixes.

S3 is well integrated with many other AWS services and may be used as a delivery destination for streaming data in Kinesis Firehose and the content of an S3 bucket can be accessed from inside an EMR cluster.

### Service Limits

The number of buckets is the only one limit given in [22] for the service. It can be increased from the initial default of 100 on request. In addition, [23] also mentions temporary limits on the request rate for the service API. In order to avoid any throttling, AWS advises to notify them beforehand if request rates are expected to rapidly increase beyond 800 GET or 300 PUT/LIST/DELETE requests per second.

### 5.1.12 Amazon DynamoDB

DynamoDB is a fully managed schemaless NoSQL database service that stores items with attributes. Before a table is created, an attribute is typically declared as the partition key. Optionally, another one can be declared as a sort key. Together these attributes form a unique primary key and every item to be stored in the table may be required to have the attributes making up the key. Aside from the primary key attributes, the items in the can be arbitrarily many other attributes. [6]

### Scalability

Internally, partition keys are hashed to assign items to data partitions. To ensure optimal performance, the partition key may be chosen to distribute the stored items equally across data partitions.

DynamoDB does not scale automatically. Instead, write capacity units (WCU) and read capacity units (RCU) to process write and read requests can be provisioned for a table when it is created [7].

RCU One read capacity unit represents one strongly consistent read, or two eventually consistent reads, per second for items smaller than 4 KB in size.

WCU One write capacity unit represents one write per second for items up to 1 KB in size.

Reading larger items uses up multiple complete RCU, and the same applies to writing items and WCU. It is possible to make more efficient use of capacity units by using batch write and read operations which consume capacity units equal to the size of the complete batch, instead for each individual item.

Should the capacity of a table be exceeded, then the service can stop accepting write or read requests. The capacity of a table can be increased an arbitrary amount of times, but it can only be decreased four times per day.

DynamoDB publishes metrics for each table to Cloudwatch. These metrics include the used write and read capacity units. A Lambda function that is triggered on a timer can evaluate these Cloudwatch metrics and adjust the provisioned capacity accordingly.

To ensure there is always enough capacity provided, the scale-up behavior can be relatively aggressive and add capacity in big steps. Scale-down behavior, on the contrary, can be very conservative. Especially if the number of capacity decreases per day are limited to four, it can be avoided to scale-down too early.

### Service Limits

Table 4h (Amazon DynamoDB service limits) stipulates limits that apply to the service and tables. A description of all limits and how to request an increase is available in [8].

### 5.1.13 Amazon RDS

Amazon RDS is a managed service providing relational database instances. Supported databases are Amazon Aurora, MySQL, MariaDB, Oracle, Microsoft SQL Server and PostgreSQL. The service handles provisioning, updating of database systems, as well as backup and recovery of databases. Depending on the database engine, it provides scale-out read replicas, automatic replication and fail-over [21].

As common in relational databases, scaling write operations is only possible by scaling vertically. Because of the variable nature of IoT data and the expected volume of writes, the RDS service is likely only an option as a result serving database.

### 5.1.14 Other Workflow Management Systems

A number of workflow management systems may be used to manage execution schedules of analytics workflows and dependencies between analytics tasks.

### Luigi

Luigi is a workflow management system originally developed for internal use at Spotify before it was released as an open source project in 2012 (https://github.com/spotify/luigi and https://www.spotify.com/).

Workflows in Luigi are expressed in Python code that describes tasks. A task can use the require statement to express its dependency on the output of other tasks. The resulting tree models the dependencies between the tasks and represents the workflow. The focus of Luigi is on the connections (or plumbing) between long running processes like Hadoop jobs, dumping/loading data from a database or machine learning algorithms It comes with tasks for executing jobs in Hadoop, Spark, Hive and Pig. Modules to run shell scripts and access common database systems are included as well. Luigi also comes with support for creating new task types and many task types have been contributed by the community [57].

Luigi uses a single central server to plan the executions of tasks and ensure that a task is executed exactly once. It uses external trigger mechanisms such as crontab for triggering tasks.

Once a worker node has received a task from the planner node, that worker is responsible for the execution of the task and all prerequisite tasks to complete it. This means the worker can execute the complete workflow and not take advantage of parallelism inside a workflow execution. This can generate a problem when running thousands of small tasks. [58, 59]

### Airflow

Airflow describes itself as “[ . . . ] a platform to programmatically author, schedule and monitor workflows.” ([30]) (https://airflow.apache.org) It was originally developed at Airbnb and was made open source in 2015 before joining the incubation program of the Apache Software Foundation in spring 2016 (https://www.airbnb.com).

Airflow workflows are modeled as directed acyclical graphs (DAG) and expressed in Python code. Workflow tasks are executed by Operator classes. The included operators can execute shell and Python scripts, send emails, execute SQL commands and Hive queries, transfer files to/from S3 and much more. Airflow executes workflows in a distributed fashion scheduling the tasks of a workflow across a fleet of worker nodes. For this reason workflow tasks may include independent units of work [1].

Airflow also features a scheduler to trigger workflows on a timer. In addition, a special Sensor operator exists which can wait for a condition to be satisfied (like the existence of a file or a database entry.) It is also possible to trigger workflows form external sources. [2]

### Oozie

Oozie is a workflow engine to manage Apache Hadoop jobs which has three main parts (https://oozie.apache.org/). The Workflow Engine manages the execution of workflows and their steps, the Coordinator Engine schedules the execution of workflows based on time and data availability and the Bundle Engine manages collections of coordinator workflows and their triggers. [75]

Workflows are modeled as directed acyclical graphs including control flow and action nodes. Action nodes represent the workflow steps which can be a Map-Reduce, Pig or SSH action for example. Workflows are written in XML and can be parameterized with a powerful expression language. [76, 77]

Oozie is available for Amazon EMR since version 4.2.0. It can be installed by enabling the Hue (Hadoop User Experience) package. [13]

### Azkaban

Azkaban is a scheduler for batch workflows executing in Hadoop (https://azkaban.github.io/). It was created at LinkedIn with a focus on usability and provides a convenient-to-use web user interface to manage and track execution of workflows (https://www.linkedin.com/).

Workflows include Hadoop jobs which may be represented as property files that describe the dependencies between jobs.

The three major components [53] making up Azkaban are:

Azkaban web server The web server handles project management and authentication. It also schedules workflows on executors and monitors executions.

Azkaban executor server The executor server schedules and supervises the execution of workflow steps. There can be multiple executor servers and jobs of a flow can execute on multiple executors in parallel.

MySQL database server The database server is used by executors and the web server to exchange workflow state information. It also keeps track of all projects, permissions on projects, uploaded workflow files and SLA rules.

Azkaban uses a plugin architecture for everything not part of the core system. This makes it easily extendable with modules that add new features and job types. Plugins that are available by default include a HDFS browser module and job types for executing shell commands, Hadoop shell commands, Hadoop Java jobs, Pig jobs, Hive queries. Azkaban even comes with a job type for loading data into Voldemort databases (https://www.project-voldemort.com/voldemort/). [54]

### Amazon Simple Workflow

If there is a need to schedule analytics and manage data flows, Amazon SWF may be a suitable service choice, being fully managed auto scaling service and capable of using Lambda, which is also an auto scaling service, to do the actual analytics work.

In SWF, workflows are implemented using special decider tasks. These tasks cannot take advantage of Lambda functions and are typically executed on servers.

SWF assumes workflow tasks to be independent of execution location. This means a database or other persistent storage outside of the analytics worker is required to aggregate the data for an analytics step. The alternative, transmitting the data required for the analytics from step to step through SWF, is not really an option, because of the maximum input and result size for a workflow step. The limit of 32,000 characters is easily exceeded e.g. by the data sent by mobile phones. This is especially true when the data from multiple data packets is aggregated.

Re-transmitting data can be avoided if it can be guaranteed that workflow steps depending on this data are executed in the same location. Task routing is a feature that enables a kind of location awareness in SWF by assigning tasks to queues that are only polled by designated workers. If every worker has its private queue, it can be ensured that tasks are always assigned to the same worker. Task routing can be cumbersome to use. A decider task for a two-step workflow with task routing implemented using the AWS Python SDK, can require close to 150 lines of code. Java Flow SDK for SWF leverages annotation processing to eliminate much boiler plate code needed for decider tasks, but does not support task routing.

A drawback is that there is no direct integration from AWS IoT to SWF which may mean the only way to start a workflow is by executing actual code somewhere and the only possibility to do this without additional servers may be to use AWS Lambda. This may mean that AWS IoT would have to invoke a function for every message that is sent to this processing lane only to signal the SWF service. According to certain embodiments, Amazon SWF is not used in the stateful stream processing lane and the lane is not implemented using services exclusively. Instead, virtual servers may be used e.g. if using Lambda functions exclusively is not desirable or possible.

### Luigi and Airflow

Amazon SWF is a possible workflow management system; other possible candidates include Luigi and Airflow which both have weaknesses in the usage scenario posed by the stateful stream processing lane.

Analytics workflows in this lane are typically short-lived and may mostly be completed in a matter of seconds, or sometimes minutes. Additionally, a very large number of workflow instances, possibly thousands, may be executed in parallel. This is similar to the scenario described by the Luigi developers in [59] in which they do not recommend using Luigi.

Airflow does not have the same scaling issues as Luigi. But Airflow has even less of a concept of task locality than Amazon SWF. Here tasks are required to be independent units of work, which includes being independent of execution location.

In addition, typically, both systems must either be integrated with AWS IoT via AWS Lambda or using an additional component that uses either the MQTT protocol or AWS SDK functions to subscribe to topics in AWS IoT. In both cases the component may be a custom piece of software and may have to be developed.

For these reasons, a workflow management system may not be used in this lane.

### Memcached and Redis

Since keeping data local to the analytics workers and aggregating the data in the windows required by the analytics may be non-trivial, caching systems may be employed to collect and aggregate incoming data.

Memcached caches may be deployed on each of the analytics worker instances. All of the management logic for inserting data into the cache may be implemented so it can be found again, assembling sliding windows, scheduling analytics executions. A single Redis cluster may be used to cache all incoming data . Redis is available in Amazon's Elasticache service and offers a lot more functionality than Memcached. It could be used as a store for the raw data and as system to queue analytics for execution on worker instances. While Redis supports scale-out for reads, it only supports scales-up for writes. Typically, scale-up requires taking the cluster offline. This not only means it is unavailable during reconfiguration, but also that any data stored in the cache is lost unless a snapshot was created beforehand.

The function can be easily deployed for multiple tables and a different set of limits for the maximum and minimum allowed read and write capacities as well as the size of the increase and decrease steps can be defined for each table without needing to change its source code.

As an alternative autoscaling functionality is now also provided by Amazon as part of the DynamoDB service.

The classes of FIG. 3b may be regarded as example classes.

Analysis of common analytics use cases e.g. as described herein with reference to analytics classes, yielded a classification system that categorizes analytics use cases or families thereof into one of various analytics classes e.g. the following 4 classes, using the dimensions shown and described herein:

CLASS A—Stateless, streaming, data point granularity

CLASS B—Stateless, streaming, data packet granularity

CLASS C—Stateful, streaming, data shard granularity

CLASS D—Stateful, batch, data chunk granularity

Mapping a distribution of common analytics use cases across the classes yielded the insight that a platform capable of supporting the requirements of at least the above four classes would be able to support generally all common analytics use cases. for example, a platform may be designed as a three layered architecture where the central processing layer includes three lanes that each support different types of analytics classes. For example, a stateless stream processing lane may cover or serve one or both of classes A and B, and/or a Stateful stream processing lane may serve class C and/or a Stateful batch processing lane may serve class D. A Raw data pass-through lane may be provided that does no analytics hence supports or covers none of the above classes.

In FIG. 3c inter alia, it is appreciated that uni-directional data flow as indicated by uni-directional arrows may according to certain embodiments be bi-directional, and vice versa. For example, the arrow between the data ingestion layer component and stateful stream processing lane may be bi-directional, although this need not be the case, the pre-processed data arrow between data ingestion and stateless processing may be bi-directional, although this need not be the case, and so forth.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Any “if -then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true and never by determinations that x is false.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order, may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting. Headings and sections herein as well as numbering thereof, is not intended to be interpretative or limiting.

1. A data processing system comprising:
At least one processing layer split into plural lanes operative for concurrent processing, using processor circuitry, in accordance with different analytics requirements;
At least one initial data ingestion layer operative for ingestion of data and for routing said data, using processor circuitry, to one of said plural lanes; and
A data storage layer aka persistence layer, receiving and storing outputs from said plural lanes,
wherein said lanes include:
a. a raw data pass-through lane which writes data received from the ingestion layer unaltered to the data storage layer;
b. a batch processing lane operative for batch processing, using processor circuitry, of chunks of data received from the data storage layer;
c. a stateless stream processing lane to which data delivered as a stream of data packets is routed by the ingestion layer for stateless analytics, using processor circuitry, performed for at least some of said packets, and wherein, in the stateless lane, scaling is achieved by distributing data routed to the stateless stream processing lane across more vs. less computational resources; and
d. a stateful stream processing lane to which data delivered as a stream of data packets is routed by the ingestion layer for stateful analytics, using processor circuitry, and wherein in the stateful lane, scaling is achieved by distributing data streams across more vs. less computational resources while preserving each stream's integrity by assigning each given stream to only one resource.

2. A system according to claim 1 wherein the data storage layer is operative for feeding outputs from one of said lanes (lane L) back into lane L.

3. A system according to claim 1 wherein at least one of the stream processing lanes is operative to pre-process data thereby to generate pre-processed data, and to feed said pre-processed data back to the data ingestion layer.

4. A system according to claim 1 wherein the batch processing lane operates on at least one of a fixed-schedule or an on-demand schedule.

5. A system according to claim 1 wherein the Data ingestion layer receives incoming data packets from at least one of the following data feeds: a sensor, a smart phone, a social web, a general external application, and an external Analytics device which provides results extracted from raw data e.g. by (a) detecting people or other events in a raw data video stream sent to the device by a camera, using software analytics, and generating people present/absent results and/or by (b) detecting audio events in a raw-data audio stream sent to the device, using software analytics, and generating audio event present/absent results.

6. A system according to claim 1 wherein the Data ingestion layer routes incoming data packets to lanes based on at least one packet attribute, said attribute characterizing at least one of the packet's content and the packet's origin.

7. A system according to claim 1 wherein said data comprises IoT data.

8. A system according to claim 1 wherein herein said concurrent processing comprises parallel processing including coordination between the lanes including time syncing where data stemming from the same time is processed at the same time such that data points within the different lanes always have the same time-stamp because faster lane/s wait/s for slower lane/s.

9. A system according to claim 1 wherein outputs from said plural lanes are fed back to the at least one processing layer.

10. A system according to claim 1 wherein said stateless analytics are performed asynchronously for at least some of said packets.

11. A system according to claim 1 wherein at least one of said lanes is cloned for scaling.

12. A system according to claim 1 wherein said distributing which achieves scaling is performed by the data ingestion layer which groups incoming data based on content.

13. A system according to claim 12 wherein the data ingestion layer groups incoming sensor data provided by plural sensors each associated with a unique identifier, based at least partly on said unique identifier.

14. A system according to claim 12 wherein the data ingestion layer groups incoming data based on a distribution key provided by a data base table.

15. A system according to claim 1 wherein the data storage layer is operative for feeding outputs from a first one of said lanes into a second one of said lanes.

16. A system according to claim 1 wherein the data storage layer is operative for feeding at least raw data from the pass-through lane to the batch processing lane.

17. A system according to claim 1 wherein the data storage layer is operative for feeding at least analytics results generated by at least one of the stream processing lanes, to the batch processing lane.

18. A system according to claim 1 wherein said lanes include at least one lane that operates on individual data points.

19. A system according to claim 1 wherein said ingestion layer performs at least one of Authentication and Anonymization.

20. A system according to claim 1 wherein said Scaling includes cloning the stateful stream processing lane according to shards, said cloning according to shards being characterized in that each assigned shard is assigned in its entirety to a single clone.

21. A system according to claim 1 wherein the raw data pass-through lane is scaled horizontally.

22. A system according to claim 1 wherein the raw data pass-through lane is scaled vertically.

23. A system according to claim 1 wherein the batch processing lane is scaled horizontally.

24. A system according to claim 1 wherein the batch processing lane is scaled vertically.

25. A system according to claim 1 wherein at least one analytics result from at least one stream processing lane, provided by said data storage layer, is used as an input to said stateful stream processing lane.

26. A system according to claim 1 wherein at least one analytics result from at least one stream processing lane, provided by said data storage layer, is used as an input to said stateless stream processing lane.

27. A system according to claim 1 wherein said stateless analytics is performed asynchronously for at least some of said packets.

28. A data processing method comprising:
In at least one processing layer split into plural lanes, performing concurrent processing e.g. in accordance with plural analytics requirements respectively;
In at least one initial data ingestion layer performing ingestion of data and routing said data to one of said plural lanes; and
In a data storage layer aka persistence layer, receiving and storing outputs from said plural lanes,
wherein said lanes include:
a. a raw data pass-through lane which writes data received from the ingestion layer unaltered to the data storage layer;
b. a batch processing lane operative for batch processing, using processor circuitry, of chunks of data received from the data storage layer;
c. a stateless stream processing lane to which data delivered as a stream of data packets is routed by the ingestion layer for stateless analytics, using processor circuitry, performed for at least some of said packets, and wherein, in the stateless lane, scaling is achieved by distributing data routed to the stateless stream processing lane across more vs. less computational resources; and
d. a stateful stream processing lane to which data delivered as a stream of data packets is routed by the ingestion layer for stateful analytics, using processor circuitry, and wherein in the stateful lane, scaling is achieved by distributing data streams across more vs. less computational resources while preserving each stream's integrity by assigning each given stream to only one resource.

29. A computer program product, comprising a non-transitory tangible computer readable medium having computer readable program code embodied therein, said computer readable program code adapted to be executed to implement a data processing method comprising:
In at least one processing layer split into plural lanes, performing concurrent processing, using processor circuitry, e.g. in accordance with plural analytics requirements respectively;
In at least one initial data ingestion layer performing ingestion of data and routing said data to one of said plural lanes; and
In a data storage layer aka persistence layer, receiving and storing outputs from said plural lanes,
wherein said lanes include:
a. a raw data pass-through lane which writes data received from the ingestion layer unaltered to the data storage layer;
b. a batch processing lane operative for batch processing of chunks of data received from the data storage layer;
c. a stateless stream processing lane to which data delivered as a stream of data packets is routed by the ingestion layer for stateless analytics, using processor circuitry, performed for at least some of said packets, and wherein, in the stateless lane, scaling is achieved by distributing data routed to the stateless stream processing lane across more vs. less computational resources; and
d. a stateful stream processing lane to which data delivered as a stream of data packets is routed by the ingestion layer for stateful analytics, using processor circuitry, and wherein in the stateful lane, scaling is achieved by distributing data streams across more vs. less computational resources while preserving each stream's integrity by assigning each given stream to only one resource.
